(19) United States
(12) Patent Application Publication
(10) Pub. No.: US 2025/0056557 A1
(43) Pub. Date: Feb. 13, 2025

(54) WINDOW CONFIGURATION FOR CELLULAR DISCONTINUOUS COMMUNICATIONS

(71) Applicant: QUALCOMM Incorporated, San Diego, CA (US)

(72) Inventors: Jae Ho RYU, San Diego, CA (US); Hung Dinh LY, San Diego, CA (US); Yuchul KIM, San Diego, CA (US); Changhwan PARK, San Diego, CA (US)

(21) Appl. No.: 18/644,743

(22) Filed: Apr. 24, 2024

Related U.S. Application Data
(60) Provisional application No. 63/518,616, filed on Aug. 10, 2023.

(51) Int. Cl. H04W 72/232; H04W 76/28

(52) U.S. Cl. CPC H04W 72/232; H04W 76/28

(57) ABSTRACT

Methods, systems, and devices for wireless communication are described that provide for aligning a starting time of a cell-based discontinuous transmission (DTX) and/or discontinuous reception (DRX) mode between a network entity and one or more user equipment (UE) within the serving cell associated with the network entity. The aligning may be accomplished via coordinated signaling. For example, the network may configure a periodic interval for transmitting information related to a discontinuous operation mode in group common downlink control information (GC DCI) messages. In some additional examples, the periodic interval may allow for beam sweeping of the GC DCI messages and efficient cell-based activation or deactivation of the discontinuous operation mode.

### CROSS REFERENCE

The present application for patent claims the benefit of U.S. Provisional Patent Application No. 63/518,616 by RYU et al., entitled “WINDOW CONFIGURATION FOR CELLULAR DISCONTINUOUS COMMUNICATIONS,” filed Aug. 10, 2023, assigned to the assignee hereof, and expressly incorporated by reference herein.

### FIELD OF TECHNOLOGY

The following relates to wireless communication, including a window configuration for cellular discontinuous communications.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations, each supporting wireless communication for communication devices, which may be known as user equipment (UE).

A network entity in a serving cell may employ a discontinuous transmission (DTX) mode, a discontinuous reception (DRX) mode, or both, for power savings. The DTX mode and the DRX mode may include a time duration during which the network entity limits transmissions to one or more UEs in the serving cell or limits receptions from the one or more UEs in the serving cell, respectively. In some cases, the network entity does not transmit any transmissions during the DTX mode and does not receive any transmissions in the DRX mode.

### SUMMARY

The described techniques relate to improved methods, systems, devices, and apparatuses that support a window configuration for cellular (e.g., cellular, serving cell-based) discontinuous communications. For example, the described techniques provide for aligning a starting time of a cell-based discontinuous transmission (DTX) and/or discontinuous reception (DRX) mode between a network entity and one or more user equipment (UEs) within a serving cell associated with the network entity. The aligning may be accomplished via coordinated signaling. For example, the network may configure a periodic interval for transmitting information related to cell-based discontinuous communications in group common downlink control information (GC DCI) messages. In some additional or alternative examples, the periodic interval may allow for beam sweeping of the GC DCI messages and efficient cell-based activation or deactivation of the cell-based discontinuous operation mode.

A method for wireless communication by a UE is described. The method may include receiving control information that indicates a periodic interval and a monitoring window within the periodic interval, where the monitoring window is for receipt of one or more instances of a GC DCI message, receiving, within the monitoring window, at least one instance of the GC DCI message in accordance with the control information, the at least one instance of the GC DCI message including a configuration for a cell-based discontinuous operation mode, and communicating with a network entity in accordance with the configuration for the cell-based discontinuous operation mode.

A UE for wireless communication is described. The UE may include one or more memories storing processor executable code, and one or more processors coupled with the one or more memories. The one or more processors may individually or collectively operable to execute the code to cause the UE to receive control information that indicates a periodic interval and a monitoring window within the periodic interval, where the monitoring window is for receipt of one or more instances of a GC DCI message, receive, within the monitoring window, at least one instance of the GC DCI message in accordance with the control information, the at least one instance of the GC DCI message including a configuration for a cell-based discontinuous operation mode, and communicate with a network entity in accordance with the configuration for the cell-based discontinuous operation mode.

Another UE for wireless communication is described. The UE may include means for receiving control information that indicates a periodic interval and a monitoring window within the periodic interval, where the monitoring window is for receipt of one or more instances of a GC DCI message, means for receiving, within the monitoring window, at least one instance of the GC DCI message in accordance with the control information, the at least one instance of the GC DCI message including a configuration for a cell-based discontinuous operation mode, and means for communicating with a network entity in accordance with the configuration for the cell-based discontinuous operation mode.

A non-transitory computer-readable medium storing code for wireless communication is described. The code may include instructions executable by a processor to receive control information that indicates a periodic interval and a monitoring window within the periodic interval, where the monitoring window is for receipt of one or more instances of a GC DCI message, receive, within the monitoring window, at least one instance of the GC DCI message in accordance with the control information, the at least one instance of the GC DCI message including a configuration for a cell-based discontinuous operation mode, and communicate with a network entity in accordance with the configuration for the cell-based discontinuous operation mode.

In some examples of the method, UEs, and non-transitory computer-readable medium described herein, the control information indicates a duration for the periodic interval, a starting offset for the periodic interval relative to a radio frame boundary, or both.

In some examples of the method, UEs, and non-transitory computer-readable medium described herein, the control information indicates a duration for the monitoring window, one or more control channel monitoring occasions within the monitoring window for receipt of the at least one instance of the GC DCI message, a starting offset for the monitoring window relative to a first symbol of the periodic interval, or any combination thereof.

In some examples of the method, UEs, and non-transitory computer-readable medium described herein, receiving the at least one instance of the GC DCI message may include operations, features, means, or instructions for receiving the at least one instance of the GC DCI message during a first monitoring occasion of one or more monitoring occasions within the monitoring window and refraining from monitoring at least one other monitoring occasion of the one or more monitoring occasions that occurs after the first monitoring occasion within the monitoring window based on receipt of the at least one instance of the GC DCI message during the first monitoring occasion.

In some examples of the method, UEs, and non-transitory computer-readable medium described herein, the control information indicates a delay duration between a last symbol of a downlink control channel received within the monitoring window and a first slot of a second periodic interval following the periodic interval and an instance of the GC DCI message may be received via the downlink control channel.

In some examples of the method, UEs, and non-transitory computer-readable medium described herein, the delay duration may be larger than or equal to a threshold quantity of symbols.

In some examples of the method, UEs, and non-transitory computer-readable medium described herein, the threshold quantity of symbols may be a set quantity of symbols that corresponds to a subcarrier spacing of a set of multiple subcarrier spacings for symbols of the downlink control channel within the monitoring window.

Some examples of the method, UEs, and non-transitory computer-readable medium described herein may further include operations, features, means, or instructions for transmitting, to the network entity, a UE capability report that indicates a minimum delay duration supported by the UE, where the threshold quantity of symbols may be based on the UE capability report.

In some examples of the method, UEs, and non-transitory computer-readable medium described herein, the threshold quantity of symbols may be based on whether the configuration for the cell-based discontinuous operation mode indicates an activation status or a deactivation status, whether the configuration for the cell-based discontinuous operation mode configures one or more of a DRX mode or a DTX mode, or both.

In some examples of the method, UEs, and non-transitory computer-readable medium described herein, the at least one instance of the GC DCI message includes a one-bit indication of an activation or deactivation of the cell-based discontinuous operation mode when the cell-based discontinuous operation mode includes a DRX mode and DTX mode that may be jointly configured.

In some examples of the method, UEs, and non-transitory computer-readable medium described herein, the at least one instance of the GC DCI message includes a two-bit indication of an activation or deactivation of the cell-based discontinuous operation mode when the cell-based discontinuous operation mode includes a DRX mode and a DTX mode that may be separately configured and a first bit of the two-bit indication corresponds to the DRX mode and a second bit of the two-bit indication corresponds to the DTX mode.

In some examples of the method, UEs, and non-transitory computer-readable medium described herein, the at least one instance of the GC DCI message includes an indication of an activation status or a deactivation status of the cell-based discontinuous operation mode for a set of serving cells configured by the network entity and the activation status or the deactivation status may be applied to the cell-based discontinuous operation mode for each serving cell of the set of serving cells.

Some examples of the method, UEs, and non-transitory computer-readable medium described herein may further include operations, features, means, or instructions for monitoring for the at least one instance of the GC DCI message in a primary serving cell associated with the UE or in a special serving cell associated with the UE, or both, where receiving the at least one instance of the GC DCI message may be based on the monitoring.

In some examples of the method, UEs, and non-transitory computer-readable medium described herein, each of the one or more instances of the GC DCI message within the monitoring window includes a same DCI message.

In some examples of the method, UEs, and non-transitory computer-readable medium described herein, the cell-based discontinuous operation mode may be a cell DRX mode, a cell DTX mode, or both.

A method for wireless communication by a network entity is described. The method may include transmitting control information that indicates a periodic interval and a monitoring window within the periodic interval, where the monitoring window is for transmission of one or more instances of a GC DCI message to one or more UEs, transmitting, within the monitoring window, at least one instance of the GC DCI message in accordance with the control information, the at least one instance of the GC DCI message including a configuration for a cell-based discontinuous operation mode, and communicating with at least one UE of the one or more UEs in accordance with the configuration for the cell-based discontinuous operation mode.

A network entity for wireless communication is described. The network entity may include one or more memories storing processor executable code, and one or more processors coupled with the one or more memories. The one or more processors may individually or collectively operable to execute the code to cause the network entity to transmit control information that indicates a periodic interval and a monitoring window within the periodic interval, where the monitoring window is for transmission of one or more instances of a GC DCI message to one or more UEs, transmit, within the monitoring window, at least one instance of the GC DCI message in accordance with the control information, the at least one instance of the GC DCI message including a configuration for a cell-based discontinuous operation mode, and communicate with at least one UE of the one or more UEs in accordance with the configuration for the cell-based discontinuous operation mode.

Another network entity for wireless communication is described. The network entity may include means for transmitting control information that indicates a periodic interval and a monitoring window within the periodic interval, where the monitoring window is for transmission of one or more instances of a GC DCI message to one or more UEs, means for transmitting, within the monitoring window, at least one instance of the GC DCI message in accordance with the control information, the at least one instance of the GC DCI message including a configuration for a cell-based discontinuous operation mode, and means for communicating with at least one UE of the one or more UEs in accordance with the configuration for the cell-based discontinuous operation mode.

A non-transitory computer-readable medium storing code for wireless communication is described. The code may include instructions executable by a processor to transmit control information that indicates a periodic interval and a monitoring window within the periodic interval, where the monitoring window is for transmission of one or more instances of a GC DCI message to one or more UEs, transmit, within the monitoring window, at least one instance of the GC DCI message in accordance with the control information, the at least one instance of the GC DCI message including a configuration for a cell-based discontinuous operation mode, and communicate with at least one UE of the one or more UEs in accordance with the configuration for the cell-based discontinuous operation mode.

In some examples of the method, network entities, and non-transitory computer-readable medium described herein, the control information indicates a duration for the periodic interval, a starting offset for the periodic interval relative to a radio frame boundary, or both.

In some examples of the method, network entities, and non-transitory computer-readable medium described herein, the control information indicates a duration for the monitoring window, one or more control channel monitoring occasions within the monitoring window for receipt of the at least one instance of the GC DCI message, a starting offset for the monitoring window relative to a first symbol of the periodic interval, or any combination thereof.

In some examples of the method, network entities, and non-transitory computer-readable medium described herein, the control information indicates a delay duration between a last symbol of a downlink control channel transmitted within the monitoring window and a first slot of a second periodic interval following the periodic interval and an instance of the GC DCI message may be transmitted via the downlink control channel.

In some examples of the method, network entities, and non-transitory computer-readable medium described herein, the delay duration may be larger than or equal to a threshold quantity of symbols that corresponds to a subcarrier spacing of a set of multiple subcarrier spacings for symbols of the downlink control channel within the monitoring window.

Some examples of the method, network entities, and non-transitory computer-readable medium described herein may further include operations, features, means, or instructions for receiving, from the at least one UE, one or more UE capability reports that indicate respective minimum delay durations supported by each respective UE of the at least one UE, where the delay duration may be larger than or equal to a quantity of symbols associated with a largest delay duration of the respective minimum delay durations.

In some examples of the method, network entities, and non-transitory computer-readable medium described herein, the delay duration may be larger than or equal to a threshold quantity of symbols that may be based on whether the configuration for the cell-based discontinuous operation mode indicates an activation status or a deactivation status, whether the configuration for the cell-based discontinuous operation mode configures one or more of a DRX mode or a DTX mode, or both.

In some examples of the method, network entities, and non-transitory computer-readable medium described herein, the at least one instance of the GC DCI message includes a one-bit indication of an activation status or a deactivation status of the cell-based discontinuous operation mode when the cell-based discontinuous operation mode includes a DRX mode and a DTX mode that may be jointly configured or a two-bit indication of the activation status or the deactivation status of the cell-based discontinuous operation mode when the cell-based discontinuous operation mode includes the DRX mode and the DTX mode that may be separately configured.

In some examples of the method, network entities, and non-transitory computer-readable medium described herein, the at least one instance of the GC DCI message includes an indication of an activation status or a deactivation status of the cell-based discontinuous operation mode for a set of serving cells configured by the network entity and the activation status or the deactivation status may be applied to the cell-based discontinuous operation mode for each serving cell of the set of serving cells.

In some examples of the method, network entities, and non-transitory computer-readable medium described herein, transmitting the at least one instance of the GC DCI message may include operations, features, means, or instructions for transmitting, during a beam sweep, a first instance of the GC DCI message via a first transmit beam and transmitting, during the beam sweep, a second instance of the GC DCI message via a second transmit beam that may be different from the first transmit beam.

### BRIEF DESCRIPTION OF THE DRAWINGS

FIG. 1 shows an example of a wireless communications system that supports window configuration for cellular discontinuous communications in accordance with one or more aspects of the present disclosure.

FIG. 2 shows an example of a wireless communications system that supports window configuration for cellular discontinuous communications in accordance with one or more aspects of the present disclosure.

FIG. 3 shows an example of a signaling diagram that supports window configuration for cellular discontinuous communications in accordance with one or more aspects of the present disclosure.

FIG. 4 shows an example of a signaling diagram, that supports window configuration for cellular discontinuous communications in accordance with one or more aspects of the present disclosure.

FIG. 5 shows an example of a process flow that supports window configuration for cellular discontinuous communications in accordance with one or more aspects of the present disclosure.

FIGS. 6 and 7 show block diagrams of devices that support window configuration for cellular discontinuous communications in accordance with one or more aspects of the present disclosure.

FIG. 8 shows a block diagram of a communications manager that supports window configuration for cellular discontinuous communications in accordance with one or more aspects of the present disclosure.

FIG. 9 shows a diagram of a system including a device that supports window configuration for cellular discontinuous communications in accordance with one or more aspects of the present disclosure.

FIGS. 10 and 11 show block diagrams of devices that support window configuration for cellular discontinuous communications in accordance with one or more aspects of the present disclosure.

FIG. 12 shows a block diagram of a communications manager that supports window configuration for cellular discontinuous communications in accordance with one or more aspects of the present disclosure.

FIG. 13 shows a diagram of a system including a device that supports window configuration for cellular discontinuous communications in accordance with one or more aspects of the present disclosure.

FIGS. 14 and 15 show flowcharts illustrating methods that support window configuration for cellular discontinuous communications in accordance with one or more aspects of the present disclosure.

### DETAILED DESCRIPTION

A network entity may employ cell-based discontinuous operation, including a cell-based discontinuous transmission (DTX) mode and a cell-based discontinuous reception (DRX) mode, or both, to increase power savings and improve overall device coordination and efficiency in a wireless communications system. For example, cell-based DTX and DRX communications may decrease network power consumption and decrease overall resource utilization by allowing the network entity (and corresponding user equipment (UE)) to periodically enter a sleep state during a set of configured “off” durations (e.g., non-active periods) of a DTX or DRX cycle. For example, a DTX off duration may be a duration of the DTX cycle in which the network entity does not transmit signaling, and a DRX off duration may be a duration of the DRX cycle in which the network device does not receive signaling. In contrast, a DTX “on” duration (e.g., active period) may be a duration of the DTX cycle in which the network entity transmits signaling, and a DRX on duration may be a duration of the DRX cycle in which the network entity receives signaling.

To notify one or more UEs in a serving cell associated with the network entity about upcoming cell-based DTX or DRX communication modes, the network entity may transmit control signaling (e.g., control information, control messaging) to the one or more UEs via a group common downlink control information (GC DCI) message format, which utilizes a common scheduling for the DTX or DRX communications for the one or more UEs. In some cases, however, the one or more UEs may not know when the network entity transmits the GC DCI, and the one or more UEs may not know when an on duration of the cell-based DTX or DRX begins. In such cases, the one or more UEs may potentially mis-detect the GC DCI and may wake up during an off duration, leading to power loss as the one or more UEs monitor for the GC DCI (e.g., or other DTX communications) during the configured off duration.

Techniques described herein provide for aligning a starting time of a cell-based discontinuous operational mode, including DTX and DRX modes, between a network entity and one or more UEs within a serving cell associated with the network entity. The aligning may be accomplished via coordinated signaling. For example, the network entity may configure a periodic interval for communicating information related to the discontinuous operational mode. The periodic interval may include a monitoring window in which the one or more UEs may expect to receive at least one instance of a GC DCI message, a duration for performing discontinuous operational mode communications, and one or more offsets or delay durations. More specifically, the network entity may configure an initial delay associated with the periodic interval, and a starting offset of a periodic interval (e.g., a chronologically or temporally first periodic interval) relative to a system frame number boundary. The network entity may also configure the monitoring window, during which the one or more UEs may monitor for one or more instances of the GC DCI message. The network entity may also configure an application delay that the one or more UEs may use to switch between a UE DTX mode and a UE DRX mode, or return to a sleep state for power savings. The network entity may also configure the monitoring window to repeat according to a periodicity. In some additional examples, the monitoring window may allow for beam sweeping of the GC DCI message and efficient cell-based activation or deactivation of the discontinuous operational mode.

Aspects of the disclosure are initially described in the context of wireless communications systems and signaling diagrams. Aspects of the disclosure are further illustrated by and described with reference to apparatus diagrams, system diagrams, and flowcharts that relate to window configuration for cellular discontinuous communications.

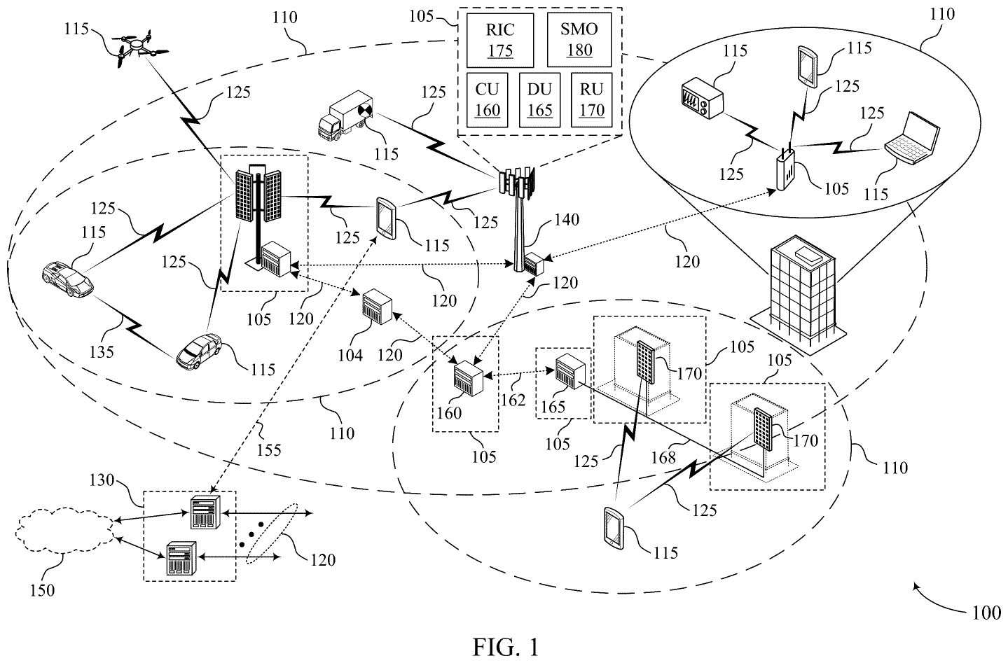

FIG. 1 shows an example of a wireless communications system 100 that supports window configuration for cellular discontinuous communications in accordance with one or more aspects of the present disclosure. The wireless communications system 100 may include one or more network entities 105, one or more UEs 115, and a core network 130. In some examples, the wireless communications system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various examples, a network entity 105 may be referred to as a network element, a mobility element, a radio access network (RAN) node, or network equipment, among other nomenclature. In some examples, network entities 105 and UEs 115 may wirelessly communicate via one or more communication links 125 (e.g., a radio frequency (RF) access link). For example, a network entity 105 may support a coverage area 110 (e.g., a geographic coverage area) over which the UEs 115 and the network entity 105 may establish one or more communication links 125. The coverage area 110 may be an example of a geographic area over which a network entity 105 and a UE 115 may support the communication of signals according to one or more radio access technologies (RATs).

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be capable of supporting communications with various types of devices, such as other UEs 115 or network entities 105, as shown in FIG. 1.

As described herein, a node of the wireless communications system 100, which may be referred to as a network node, or a wireless node, may be a network entity 105 (e.g., any network entity described herein), a UE 115 (e.g., any UE described herein), a network controller, an apparatus, a device, a computing system, one or more components, or another suitable processing entity configured to perform any of the techniques described herein. For example, a node may be a UE 115. As another example, a node may be a network entity 105. As another example, a first node may be configured to communicate with a second node or a third node. In one aspect of this example, the first node may be a UE 115, the second node may be a network entity 105, and the third node may be a UE 115. In another aspect of this example, the first node may be a UE 115, the second node may be a network entity 105, and the third node may be a network entity 105. In yet other aspects of this example, the first, second, and third nodes may be different relative to these examples. Similarly, reference to a UE 115, network entity 105, apparatus, device, computing system, or the like may include disclosure of the UE 115, network entity 105, apparatus, device, computing system, or the like being a node. For example, disclosure that a UE 115 is configured to receive information from a network entity 105 also discloses that a first node is configured to receive information from a second node.

In some examples, network entities 105 may communicate with the core network 130, or with one another, or both. For example, network entities 105 may communicate with the core network 130 via one or more backhaul communication links 120 (e.g., in accordance with an S1, N2, N3, or other interface protocol). In some examples, network entities 105 may communicate with one another via a backhaul communication link 120 (e.g., in accordance with an X2, Xn, or other interface protocol) either directly (e.g., directly between network entities 105) or indirectly (e.g., via a core network 130). In some examples, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication links 120, midhaul communication links 162, or fronthaul communication links 168 may be or include one or more wired links (e.g., an electrical link, an optical fiber link), one or more wireless links (e.g., a radio link, a wireless optical link), among other examples or various combinations thereof. A UE 115 may communicate with the core network 130 via a communication link 155.

One or more of the network entities 105 described herein may include or may be referred to as a base station 140 (e.g., a base transceiver station, a radio base station, an NR base station, an access point, a radio transceiver, a NodeB, an eNodeB (eNB), a next-generation NodeB or a giga-NodeB (either of which may be referred to as a gNB), a 5G NB, a next-generation eNB (ng-eNB), a Home NodeB, a Home eNodeB, or other suitable terminology). In some examples, a network entity 105 (e.g., a base station 140) may be implemented in an aggregated (e.g., monolithic, standalone) base station architecture, which may be configured to utilize a protocol stack that is physically or logically integrated within a single network entity 105 (e.g., a single RAN node, such as a base station 140).

In some examples, a network entity 105 may be implemented in a disaggregated architecture (e.g., a disaggregated base station architecture, a disaggregated RAN architecture), which may be configured to utilize a protocol stack that is physically or logically distributed among two or more network entities 105, such as an integrated access backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a central unit (CU) 160, a distributed unit (DU) 165, a radio unit (RU) 170, a RAN Intelligent Controller (RIC) 175 (e.g., a Near-Real Time RIC (Near-RT RIC), a Non-Real Time RIC (Non-RT RIC)), a Service Management and Orchestration (SMO) 180 system, or any combination thereof. An RU 170 may also be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (e.g., separate physical locations). In some examples, one or more network entities 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 170 is flexible and may support different functionalities depending on which functions (e.g., network layer functions, protocol layer functions, baseband functions, RF functions, and any combinations thereof) are performed at a CU 160, a DU 165, or an RU 170. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (e.g., layer 3 (L3), layer 2 (L2)) functionality and signaling (e.g., Radio Resource Control (RRC), service data adaption protocol (SDAP), Packet Data Convergence Protocol (PDCP)). The CU 160 may be connected to one or more DUs 165 or RUs 170, and the one or more DUs 165 or RUs 170 may host lower protocol layers, such as layer 1 (L1) (e.g., physical (PHY) layer) or L2 (e.g., radio link control (RLC) layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or more RUs 170). In some cases, a functional split between a CU 160 and a DU 165, or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to one or more DUs 165 via a midhaul communication link 162 (e.g., F1, F1-c, F1-u), and a DU 165 may be connected to one or more RUs 170 via a fronthaul communication link 168 (e.g., open fronthaul (FH) interface). In some examples, a midhaul communication link 162 or a fronthaul communication link 168 may be implemented in accordance with an interface (e.g., a channel) between layers of a protocol stack supported by respective network entities 105 that are in communication via such communication links.

In wireless communications systems (e.g., wireless communications system 100), infrastructure and spectral resources for radio access may support wireless backhaul link capabilities to supplement wired backhaul connections, providing an IAB network architecture (e.g., to a core network 130). In some cases, in an IAB network, one or more network entities 105 (e.g., IAB nodes 104) may be partially controlled by each other. One or more IAB nodes 104 may be referred to as a donor entity or an IAB donor. One or more DUs 165 or one or more RUs 170 may be partially controlled by one or more CUs 160 associated with a donor network entity 105 (e.g., a donor base station 140). The one or more donor network entities 105 (e.g., IAB donors) may be in communication with one or more additional network entities 105 (e.g., IAB nodes 104) via supported access and backhaul links (e.g., backhaul communication links 120). IAB nodes 104 may include an IAB mobile termination (IAB-MT) controlled (e.g., scheduled) by DUs 165 of a coupled IAB donor. An IAB-MT may include an independent set of antennas for relay of communications with UEs 115, or may share the same antennas (e.g., of an RU 170) of an IAB node 104 used for access via the DU 165 of the IAB node 104 (e.g., referred to as virtual IAB-MT (vIAB-MT)). In some examples, the IAB nodes 104 may include DUs 165 that support communication links with additional entities (e.g., IAB nodes 104, UEs 115) within the relay chain or configuration of the access network (e.g., downstream). In such cases, one or more components of the disaggregated RAN architecture (e.g., one or more IAB nodes 104 or components of IAB nodes 104) may be configured to operate according to the techniques described herein.

In the case of the techniques described herein applied in the context of a disaggregated RAN architecture, one or more components of the disaggregated RAN architecture may be configured to support window configuration for cellular discontinuous communications as described herein. For example, some operations described as being performed by a UE 115 or a network entity 105 (e.g., a base station 140) may additionally, or alternatively, be performed by one or more components of the disaggregated RAN architecture (e.g., IAB nodes 104, DUs 165, CUs 160, RUs 170, RIC 175, SMO 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, or vehicles, meters, among other examples.

The UEs 115 described herein may be able to communicate with various types of devices, such as other UEs 115 that may sometimes act as relays as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via one or more communication links 125 (e.g., an access link) using resources associated with one or more carriers. The term “carrier” may refer to a set of RF spectrum resources having a defined physical layer structure for supporting the communication links 125. For example, a carrier used for a communication link 125 may include a portion of a RF spectrum band (e.g., a bandwidth part (BWP)) that is operated according to one or more physical layer channels for a given radio access technology (e.g., LTE, LTE-A, LTE-A Pro, NR). Each physical layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between a network entity 105 and other devices may refer to communication between the devices and any portion (e.g., entity, sub-entity) of a network entity 105. For example, the terms “transmitting,” “receiving,” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities 105).

The communication links 125 shown in the wireless communications system 100 may include downlink transmissions (e.g., forward link transmissions) from a network entity 105 to a UE 115, uplink transmissions (e.g., return link transmissions) from a UE 115 to a network entity 105, or both, among other configurations of transmissions. Carriers may carry downlink or uplink communications (e.g., in an FDD mode) or may be configured to carry downlink and uplink communications (e.g., in a TDD mode).

Signal waveforms transmitted via a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (e.g., a duration of one modulation symbol) and one subcarrier, in which case the symbol period and subcarrier spacing may be inversely related. The quantity of bits carried by each resource element may depend on the modulation scheme (e.g., the order of the modulation scheme, the coding rate of the modulation scheme, or both), such that a relatively higher quantity of resource elements (e.g., in a transmission duration) and a relatively higher order of a modulation scheme may correspond to a relatively higher rate of communication. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

The time intervals for the network entities 105 or the UEs 115 may be expressed in multiples of a basic time unit which may, for example, refer to a sampling period of Tₛ=1/(Δfₘₐₓ·N_{f}) seconds, for which Δfₘₐₓ may represent a supported subcarrier spacing, and N_{f} may represent a supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively-numbered subframes or slots, and each subframe or slot may have the same duration. In some examples, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communications systems 100, a slot may further be divided into multiple mini-slots associated with one or more symbols. Excluding the cyclic prefix, each symbol period may be associated with one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (STTIs)).

Physical channels may be multiplexed for communication using a carrier according to various techniques. A physical control channel and a physical data channel may be multiplexed for signaling via a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to multiple UEs 115 and UE-specific search space sets for sending control information to a specific UE 115.

A network entity 105 may provide communication coverage via one or more cells (e.g., serving cells), for example a macro cell, a small cell, a hot spot, or other types of cells, or any combination thereof. The term “cell” may refer to a logical communication entity used for communication with a network entity 105 (e.g., using a carrier) and may be associated with an identifier for distinguishing neighboring cells (e.g., a physical cell identifier (PCID), a virtual cell identifier (VCID), or others). In some examples, a cell also may refer to a coverage area 110 or a portion of a coverage area 110 (e.g., a sector) over which the logical communication entity operates. Such cells may range from smaller areas (e.g., a structure, a subset of structure) to larger areas depending on various factors such as the capabilities of the network entity 105. For example, a cell may be or include a building, a subset of a building, or exterior spaces between or overlapping with coverage areas 110, among other examples.

A macro cell generally covers a relatively large geographic area (e.g., several kilometers in radius) and may allow unrestricted access by the UEs 115 with service subscriptions with the network provider supporting the macro cell. A small cell may be associated with a lower-powered network entity 105 (e.g., a lower-powered base station 140), as compared with a macro cell, and a small cell may operate using the same or different (e.g., licensed, unlicensed) frequency bands as macro cells. Small cells may provide unrestricted access to the UEs 115 with service subscriptions with the network provider or may provide restricted access to the UEs 115 having an association with the small cell (e.g., the UEs 115 in a closed subscriber group (CSG), the UEs 115 associated with users in a home or office). A network entity 105 may support one or multiple cells and may also support communications via the one or more cells using one or multiple component carriers.

In some examples, a carrier may support multiple cells, and different cells may be configured according to different protocol types (e.g., MTC, narrowband IoT (NB-IoT), enhanced mobile broadband (eMBB)) that may provide access for different types of devices.

In some examples, a network entity 105 (e.g., a base station 140, an RU 170) may be movable and therefore provide communication coverage for a moving coverage area 110. In some examples, different coverage areas 110 associated with different technologies may overlap, but the different coverage areas 110 may be supported by the same network entity 105. In some other examples, the overlapping coverage areas 110 associated with different technologies may be supported by different network entities 105. The wireless communications system 100 may include, for example, a heterogeneous network in which different types of the network entities 105 provide coverage for various coverage areas 110 using the same or different radio access technologies.

The wireless communications system 100 may support synchronous or asynchronous operation. For synchronous operation, network entities 105 (e.g., base stations 140) may have similar frame timings, and transmissions from different network entities 105 may be approximately aligned in time. For asynchronous operation, network entities 105 may have different frame timings, and transmissions from different network entities 105 may, in some examples, not be aligned in time. The techniques described herein may be used for either synchronous or asynchronous operations.

Some UEs 115 may be configured to employ operating modes that reduce power consumption, such as half-duplex communications (e.g., a mode that supports one-way communication via transmission or reception, but not transmission and reception concurrently). In some examples, half-duplex communications may be performed at a reduced peak rate. Other power conservation techniques for the UEs 115 include entering a power saving deep sleep mode when not engaging in active communications, operating using a limited bandwidth (e.g., according to narrowband communications), or a combination of these techniques. For example, some UEs 115 may be configured for operation using a narrowband protocol type that is associated with a defined portion or range (e.g., set of subcarriers or resource blocks (RBs)) within a carrier, within a guard-band of a carrier, or outside of a carrier.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be configured to support communicating directly with other UEs 115 via a device-to-device (D2D) communication link 135 (e.g., in accordance with a peer-to-peer (P2P), D2D, or sidelink protocol). In some examples, one or more UEs 115 of a group that are performing D2D communications may be within the coverage area 110 of a network entity 105 (e.g., a base station 140, an RU 170), which may support aspects of such D2D communications being configured by (e.g., scheduled by) the network entity 105. In some examples, one or more UEs 115 of such a group may be outside the coverage area 110 of a network entity 105 or may be otherwise unable to or not configured to receive transmissions from a network entity 105. In some examples, groups of the UEs 115 communicating via D2D communications may support a one-to-many (1:M) system in which each UE 115 transmits to each of the other UEs 115 in the group. In some examples, a network entity 105 may facilitate the scheduling of resources for D2D communications. In some other examples, D2D communications may be carried out between the UEs 115 without an involvement of a network entity 105.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. UHF waves may be blocked or redirected by buildings and environmental features, which may be referred to as clusters, but the waves may penetrate structures sufficiently for a macro cell to provide service to the UEs 115 located indoors. Communications using UHF waves may be associated with smaller antennas and shorter ranges (e.g., less than 100 kilometers) compared to communications using the smaller frequencies and longer waves of the high frequency (HF) or very high frequency (VHF) portion of the spectrum below 300 MHz.

The wireless communications system 100 may utilize both licensed and unlicensed RF spectrum bands. For example, the wireless communications system 100 may employ License Assisted Access (LAA), LTE-Unlicensed (LTE-U) radio access technology, or NR technology using an unlicensed band such as the 5 GHz industrial, scientific, and medical (ISM) band. While operating using unlicensed RF spectrum bands, devices such as the network entities 105 and the UEs 115 may employ carrier sensing for collision detection and avoidance. In some examples, operations using unlicensed bands may be based on a carrier aggregation configuration in conjunction with component carriers operating using a licensed band (e.g., LAA). Operations using unlicensed spectrum may include downlink transmissions, uplink transmissions, P2P transmissions, or D2D transmissions, among other examples.

A network entity 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network entity 105 may be located at diverse geographic locations. A network entity 105 may include an antenna array with a set of rows and columns of antenna ports that the network entity 105 may use to support beamforming of communications with a UE 115. Likewise, a UE 115 may include one or more antenna arrays that may support various MIMO or beamforming operations. Additionally, or alternatively, an antenna panel may support RF beamforming for a signal transmitted via an antenna port.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating along particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

A network entity 105 or a UE 115 may use beam sweeping techniques as part of beamforming operations. For example, a network entity 105 (e.g., a base station 140, an RU 170) may use multiple antennas or antenna arrays (e.g., antenna panels) to conduct beamforming operations for directional communications with a UE 115. Some signals (e.g., synchronization signals, reference signals, beam selection signals, or other control signals) may be transmitted by a network entity 105 multiple times along different directions. For example, the network entity 105 may transmit a signal according to different beamforming weight sets associated with different directions of transmission. Transmissions along different beam directions may be used to identify (e.g., by a transmitting device, such as a network entity 105, or by a receiving device, such as a UE 115) a beam direction for later transmission or reception by the network entity 105.

Some signals, such as data signals associated with a particular receiving device, may be transmitted by transmitting device (e.g., a transmitting network entity 105, a transmitting UE 115) along a single beam direction (e.g., a direction associated with the receiving device, such as a receiving network entity 105 or a receiving UE 115). In some examples, the beam direction associated with transmissions along a single beam direction may be determined based on a signal that was transmitted along one or more beam directions. For example, a UE 115 may receive one or more of the signals transmitted by the network entity 105 along different directions and may report to the network entity 105 an indication of the signal that the UE 115 received with a highest signal quality or an otherwise acceptable signal quality.

In some examples, transmissions by a device (e.g., by a network entity 105 or a UE 115) may be performed using multiple beam directions, and the device may use a combination of digital precoding or beamforming to generate a combined beam for transmission (e.g., from a network entity 105 to a UE 115). The UE 115 may report feedback that indicates precoding weights for one or more beam directions, and the feedback may correspond to a configured set of beams across a system bandwidth or one or more sub-bands. The network entity 105 may transmit a reference signal (e.g., a cell-specific reference signal (CRS), a channel state information reference signal (CSI-RS)), which may be precoded or unprecoded. The UE 115 may provide feedback for beam selection, which may be a precoding matrix indicator (PMI) or codebook-based feedback (e.g., a multi-panel type codebook, a linear combination type codebook, a port selection type codebook). Although these techniques are described with reference to signals transmitted along one or more directions by a network entity 105 (e.g., a base station 140, an RU 170), a UE 115 may employ similar techniques for transmitting signals multiple times along different directions (e.g., for identifying a beam direction for subsequent transmission or reception by the UE 115) or for transmitting a signal along a single direction (e.g., for transmitting data to a receiving device).

A receiving device (e.g., a UE 115) may perform reception operations in accordance with multiple receive configurations (e.g., directional listening) when receiving various signals from a transmitting device (e.g., a network entity 105), such as synchronization signals, reference signals, beam selection signals, or other control signals. For example, a receiving device may perform reception in accordance with multiple receive directions by receiving via different antenna subarrays, by processing received signals according to different antenna subarrays, by receiving according to different receive beamforming weight sets (e.g., different directional listening weight sets) applied to signals received at multiple antenna elements of an antenna array, or by processing received signals according to different receive beamforming weight sets applied to signals received at multiple antenna elements of an antenna array, any of which may be referred to as “listening” according to different receive configurations or receive directions. In some examples, a receiving device may use a single receive configuration to receive along a single beam direction (e.g., when receiving a data signal). The single receive configuration may be aligned along a beam direction determined based on listening according to different receive configuration directions (e.g., a beam direction determined to have a highest signal strength, highest signal-to-noise ratio (SNR), or otherwise acceptable signal quality based on listening according to multiple beam directions).

The UEs 115 and the network entities 105 may support retransmissions of data to increase the likelihood that data is received successfully. Hybrid automatic repeat request (HARQ) feedback is one technique for increasing the likelihood that data is received correctly via a communication link (e.g., a communication link 125, a D2D communication link 135). HARQ may include a combination of error detection (e.g., using a cyclic redundancy check (CRC)), forward error correction (FEC), and retransmission (e.g., automatic repeat request (ARQ)). HARQ may improve throughput at the MAC layer in poor radio conditions (e.g., low signal-to-noise conditions). In some examples, a device may support same-slot HARQ feedback, in which case the device may provide HARQ feedback in a specific slot for data received via a previous symbol in the slot. In some other examples, the device may provide HARQ feedback in a subsequent slot, or according to some other time interval. In some cases, HARQ feedback corresponding to GC DCIs may not be supported by the UEs 115 or the network entities 105, thus, techniques to configure and align a starting time for cell-based DTX and DRX modes may be used to increase signaling reliability for the UEs 115 and network entities 105.

Techniques described herein provide for aligning a starting time of a cell-based discontinuous communications, including cell-based DTX and DRX modes, between a network entity and one or more UEs 115 within a serving cell associated with a network entity 105. The aligning of the starting time may be accomplished via coordinated signaling. For example, the network entity 105 may configure a periodic interval for communicating information related to the discontinuous operation mode. The periodic interval may include (at least) a monitoring window in which the one or more UEs 115 may expect to receive at least one instance of a GC DCI message, a duration for performing discontinuous communications, and one or more offsets or delay durations. More specifically, the network entity 105 may configure an initial delay associated with the periodic interval, and a starting offset of a periodic interval relative to a system frame number boundary. The network entity 105 may also configure the monitoring window, during which the one or more UEs 115 may monitor for one or more instances of the GC DCI message. The network entity 105 may also configure an application delay that the one or more UEs 115 may use to switch between a UE DTX mode and a UE DRX mode, or return to a sleep state or other low power mode for power savings. The network entity 105 may also configure the monitoring window to repeat according to a periodicity. In some additional or alternative examples, the monitoring window may allow for beam sweeping of the GC DCI message and efficient cell-based activation or deactivation of the discontinuous operational mode.

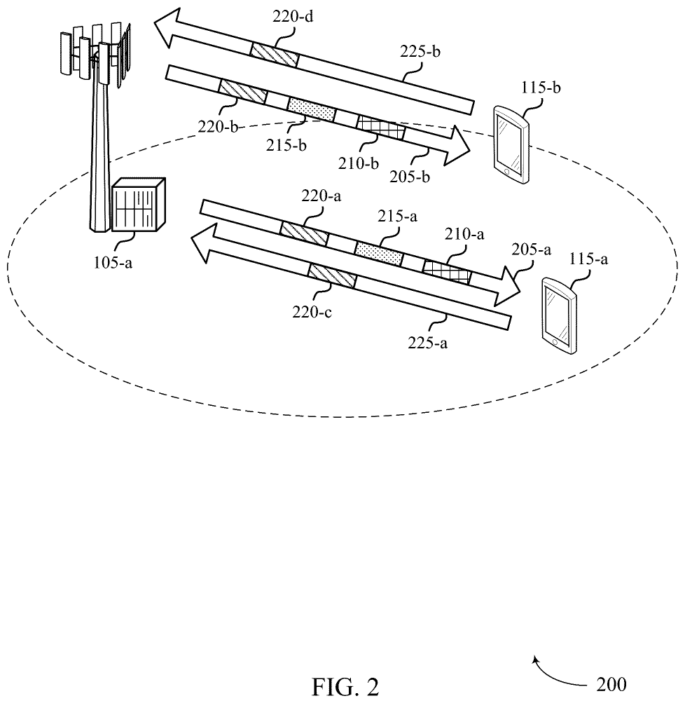

FIG. 2 shows an example of a wireless communications system 200 that supports window configuration for cellular discontinuous communications in accordance with one or more aspects of the present disclosure. Wireless communications system 200 may implement or be implemented by aspects of wireless communications system 100. For example, the wireless communications system 200 may include a network entity 105-a and UEs 115 (e.g., UE 115-a and UE 115-b), each of which may be examples of network entities 105 and UEs 115 as described with reference to FIG. 1. Although a quantity of UEs 115 and network entities 105 are depicted in the wireless communications system 200, the techniques described herein may support different quantities of UEs 115 and network entities 105 within the wireless communications system 200.

In the wireless communications system 200, the network entity 105-a may transmit information (e.g., signaling, messages, transmissions) to the UEs 115. For example, the network entity 105-a may transmit control information (e.g., control information 210-a and control information 210-b), GC DCI messaging (e.g., GC DCI messaging 215-a and GC DCI messaging 215-b), and discontinuous communications (e.g., discontinuous communications 220-a and discontinuous communications 220-b) to the UEs 115. In some cases, the network entity 105-a may transmit the information via broadcasting methods (e.g., multicast methods) to the UEs 115. Additionally or alternatively, the network entity 105-a may transmit the information to the UE 115-a and to the UE 115-b via a downlink channel 205-a and a downlink channel 205-b, respectively.

In some examples, UEs 115 may transmit information to the network entity 105-a. For example, the UEs 115 may transmit capability messaging and discontinuous communications (e.g., discontinuous communications 220-c and discontinuous communications 220-d) to the network entity 105-a. The UE 115-a and the UE 115-b may transmit the information to the network entity via an uplink channel 225-a and an uplink channel 225-b, respectively.

In some wireless communications systems such as the wireless communications system 200, GC DCI signaling may suffer from reduced communications reliability, especially in the case of indicating cell-based discontinuous operational information via the GC DCI signaling. For example, communicating HARQ feedback associated with the GC DCI signaling may not be supported by the UEs 115, the network entity 105-a, or both. Additionally or alternatively, in some cases, the UEs 115 may mis-detect (e.g., incorrectly decode, fail to detect altogether) a GC DCI message from the network entity 105-a containing information related to cell-based discontinuous operation.

In such cases, reduced reliability and misdetection of the GC DCI may negatively impact the wireless communications system 200. In one example, one or more of the UEs 115 may perform operations (e.g., loop operations, CSI, beam management (BM), radio link monitoring (RLM), radio resource management (RRM)) while downlink signaling is turned off during a cell-based DTX off duration. In another example, the UEs 115 may waste power monitoring a physical downlink control channel (PDCCH) while the network entity 105-a is not transmitting via the PDCCH during a cell-based DTX off duration. In some other examples, the UE 115 may transmit sounding reference signal (SRS) or physical random access channel (PRACH) during a cell-based DRX off duration. Each of these examples may waste wireless communications resources and increase power consumption at the UEs 115 and the network entity 105-a.

Aspects of the present disclosure are related to aligning a starting time of a discontinuous communications window between the UEs 115 and the network entity 105-a so that the UEs 115 may receive GC DCI messaging from the network entity 105-a and perform discontinuous communications with the network entity 105-a. Such alignment of the starting time eliminates association of GC DCI monitoring messages and the cell-based discontinuous communications with arbitrary slots, which increases coordination within the network since aligning multiple starting times for the cell-based discontinuous communications among different UEs would require a relatively greater amount of resources and energy.

According to aspects presented herein, and to reduce negative impacts on the wireless communications system 200, a starting time of cell-based discontinuous communications may be aligned between the UEs 115 and the network entity 105-a. The starting time of cell-based discontinuous communications may be associated with the reception time of a GC DCI message carrying information associated with cell-based discontinuous communications at the UEs 115. Additionally, or alternatively, the starting time may be associated with an application time (e.g., a duration for applying changes) based on the information associated with cell-based discontinuous communications. For example, the starting time may allow sufficient time for the UEs 115 to adjust reception operations, transmission operations, or both, (or switch between reception operations and transmission operations) based on the information associated with the cell-based discontinuous communications.

Accordingly, the network entity 105-a may transmit information associated with cell-based discontinuous communications to the UEs 115. For example, the control information 210-a and the control information 210-b may indicate a periodic interval and a monitoring window within the periodic interval. The monitoring window may be for the monitoring or receipt of the GC DCI messaging 215-a and the GC DCI messaging 215-b. In some cases, the GC DCI messaging may contain information associated with the cell-based discontinuous communications.

The network entity 105-a and the UEs 115 may transmit discontinuous communications to each other based on the information associated with cell-based discontinuous communications. For example, the network entity 105-a and the UEs 115 may transmit or receive the discontinuous communications during a DTX on duration or a DRX on duration, respectively. In some cases, this may increase the reliability and overall resource utilization in GC DCI signaling.

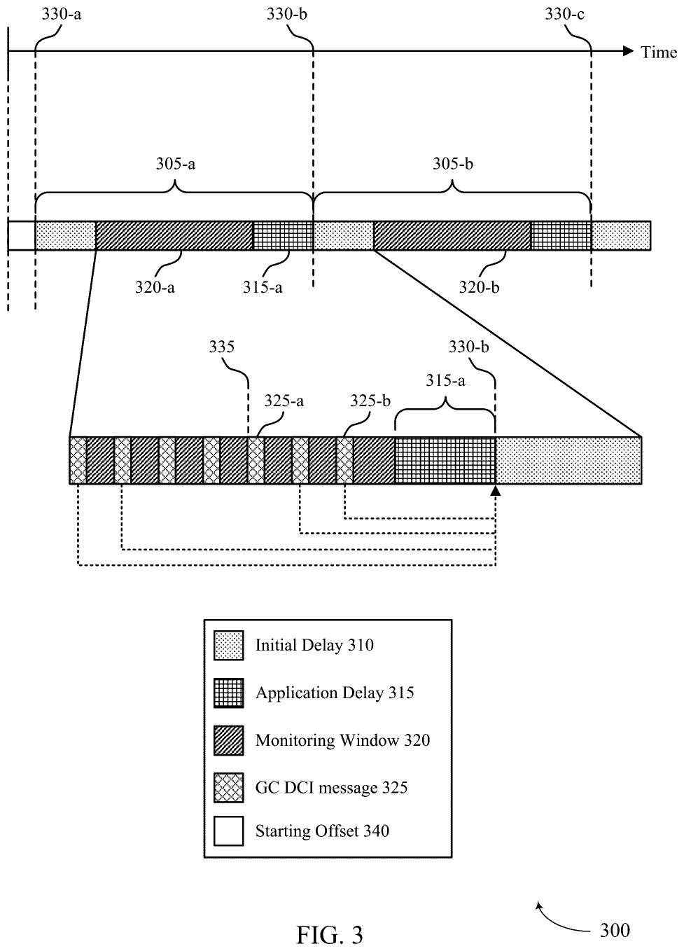

FIG. 3 shows an example of a signaling diagram 300 that supports window configuration for cellular discontinuous communications in accordance with one or more aspects of the present disclosure. The signaling diagram 300 may implement or be implemented by aspects of FIGS. 1 and 2. For example, the signaling diagram 300 may depict periodic intervals 305 (e.g., periodic interval 305-a and periodic interval 305-b) described with reference to FIG. 2, and may be implemented at or by the devices described with reference to FIGS. 1 and 2. Although exemplary quantities of durations, periods, or messages are depicted in the signaling diagram 300, it is noted that this disclosure may be generalized to include any quantity of such durations, periods, and messages.

The signaling diagram 300 may depict the periodic intervals 305 indicated by the network entity 105 of FIG. 2. The periodic intervals 305 may contain initial delays 310, application delays 315 (e.g., application delay 315-a), and monitoring windows 320 (e.g., monitoring window 320-a and monitoring window 320-b). The monitoring windows 320 may be for a network entity to transmit and a UE to receive at least one instance of a GC DCI message 325 (e.g., GC DCI message 325-a and GC DCI message 325-b). The initial delays 310 and the application delays 315 may be for the UEs 115 and the network entity 105 to implement any changes to internal configurations (e.g., receiver configurations, transmitter configurations).

A network entity may transmit an indication of a configuration of cell-based discontinuous communications to one or more UEs. For example, the configuration may include parameters, where some or all of the parameters may correspond to or configure some or all aspects of the signaling diagram 300. For example, the parameters may include an initiation interval configuration that may indicate a period (e.g., duration, recurring duration) of the periodic intervals 305. The initiation interval configuration may indicate the period of the periodic intervals 305 as a quantity of slots, symbols, TTIs, or other units time or resources. Additionally or alternatively, the initiation interval configuration may indicate a starting offset 340 of one or more periodic intervals (e.g., an initial or chronologically first periodic interval, periodic interval 305-a) relative to a radio frame boundary (e.g., an SFN frame boundary).

The parameters of the configuration of cell-based discontinuous communications may include a monitoring window configuration (e.g., GC DCI monitoring window configuration). The monitoring window configuration may indicate a duration of the monitoring windows 320. In some cases, the monitoring window configuration may indicate the duration of the monitoring windows 320 as a quantity of slots, symbols, TTIs, or other units of time or resources. The monitoring window configuration may also indicate one or more monitoring occasions (e.g., PDCCH monitoring occasions, time resources, frequency resources) within the monitoring windows 320, where the one or more monitoring occasions may be for the network entity to transmit and for one or more UEs to receive one or more instances of a GC DCI message 325. The monitoring window configuration may also indicate the initial delays 310 before the monitoring windows 320 within the periodic intervals 305. For example, the monitoring window configuration may indicate a duration of the initial delays 310 as a quantity of slots, symbols, TTIs, or other units of time or resources.

The parameters of the configuration of cell-based discontinuous communications may include an application delay configuration, corresponding to the application delays 315. The application delay 315 may be a duration between a last symbol of a monitoring occasion carrying an instance of the GC DCI message and a starting slot of a next periodic interval. For example, the application delay 315-a may be the duration between the last symbol of the PDCCH carrying GC DCI message 325-b and the starting slot of periodic interval 305-b.

The network entity may utilize the application indication delay configuration to ensure that the application delays 315 are greater than or equal to a threshold quantity of symbols (e.g., OFDM symbols). In some cases, the threshold quantity of symbols may be specified (e.g., preconfigured at the network entity, preconfigured at the UE) per subcarrier spacing of associated PDCCH symbols. Additionally or alternatively, the threshold quantity of symbols may be a value (e.g., a maximum value) among a set of values reported in a UE capability report. For example, each of the UEs may report a value corresponding to a smallest quantity of symbols in which the UE is capable of applying changes for the discontinuous operational mode indicated by a GC DCI message 325. In such examples, the network entity may select the largest of the values reported by the UEs as the threshold quantity of symbols for the application delays 315 so that the UEs have sufficient time to adapt their operation in response to the indication by a GC DCI message. Additionally or alternatively, the threshold quantity of symbols may be dependent on whether the GC DCI message is indicative of a cell-based DTX mode or a cell-based DRX mode, and may be dependent on whether the GC DCI message is activating or deactivating cell-based discontinuous communications.

The network entity may transmit one or more GC DCI messages within each of the monitoring windows 320. For example, the network entity 105 may transmit GC DCI message 325-a and GC DCI message 325-b within the monitoring window 320-a. The GC DCI message 325-a and the GC DCI message 325-b may be instances of a first GC DCI message. Stated differently, the GC DCI messages 325 in a monitoring window, such as the monitoring window 320-a, may all carry the same contents (e.g., content of the DCI messages). The monitoring window 320-b may contain a same or different quantity of GC DCI messages 325 as the monitoring window 320-a. Additionally, the GC DCI messages 325 of the monitoring window 320-b may be instances of a second GC DCI message, where the first GC DCI message and the second GC DCI message may carry the same or different contents. Although a quantity of GC DCI messages 325 are depicted herein, it is noted that this disclosure may be extended to include any quantity of GC DCI messages 325 within each monitoring window 320.

The GC DCI messages 325 may indicate information associated with cell-based discontinuous communications. For example, the GC DCI messages 325 of the monitoring window 320-a may include an indication of an activation or a deactivation (e.g., an activation status or deactivation status) of cell-based discontinuous communications. The indication of the activation or the deactivation of cell-based discontinuous communications may be associated with (e.g., take effect at) a starting candidate position (e.g., a starting candidate position 330-a, a starting candidate position 330-b, and a starting candidate position 330-c) of a next periodic interval. For example, an indication of an activation of cell-based discontinuous communications received in the monitoring window 320-a may indicate that cell-based discontinuous communications will activate at the starting candidate position 330-b.

In some examples, the UEs may monitor all or part of the monitoring windows 320. For example, a UE may monitor the monitoring window 320-a until a time 335, at which point the UE may receive (e.g., decode, detect) the GC DCI message 325-a. In some examples, the UE may refrain from monitoring for the rest of the GC DCI messages 325 (e.g., other PDCCH monitoring occasions) within the monitoring window 320-a after the time 335 based on having received the GC DCI message 325. In some other examples, the UE may continue to monitor for the rest of the GC DCI messages 325 within the monitoring window 320-a after the time 335.

According to some aspects of the disclosure, a network entity may transmit more than one GC DCI message in the monitoring windows 320 to lower a probability of a UE mis-detecting a GC DCI message 325, as discussed herein. In some cases, the network entity may decide or configure a quantity of PDCCH monitoring occasions and corresponding GC DCI messages 325 that are configured and transmitted within each monitoring window 320.

In some cases, a UE may monitor all serving cells communicating with the UE for the GC DCI messages 325 during the monitoring windows 320. In some other cases, a UE may monitor specific serving cells for the GC DCI messages during the monitoring windows 320. For example, the UE may monitor a primary serving cell, a special serving cell (e.g., a primary serving cell and a combination of the primary serving cell and a secondary serving cell), or both, for the GC DCI messages 325 during the monitoring windows 320.

Additionally or alternatively, the GC DCI messages 325 may carry other information associated with window configuration for cellular discontinuous communications. For example, the GC DCI messages 325 may indicate a common flag that indicates an activation or deactivation of the discontinuous operational mode for a quantity of serving cells. For example, of a set of serving cells, a subset of the serving cells may correspond to the common flag. The subset of serving cells may be configured by the network entity (e.g., a lead network entity, the network entity transmitting the GC DCI messages 325), and the configuration may be performed or indicated via RRC signaling.

In some examples, the network entity may transmit a GC DCI message 325 comprising the common flag, which may indicate an activation or deactivation of the discontinuous communications for the subset of serving cells. At a starting candidate position, each serving cell in the subset of serving cells may activate or deactivate the discontinuous communications within the respective serving cell, according to the activation or deactivation indicated by the common flag.

The discontinuous communications may include cell-based discontinuous operational modes, including a DTX mode, a DRX mode, or both, which may be configured jointly or separately. If the DTX mode and the DRX mode are configured separately, the indication of activation or deactivation of the discontinuous operational mode may comprise two bits, such that one bit indicates activation or deactivation for the DTX mode, and the other bit indicates activation or deactivation for the DRX mode. In some other examples, if the DTX mode and the DRX mode are configured jointly, the indication of activation or deactivation of the discontinuous operational mode may comprise one common bit, where the one common bit indicates activation or deactivation of both the DTX mode and the DRX mode. In some cases, the one common bit may provide for lower DCI overhead compared to other options.

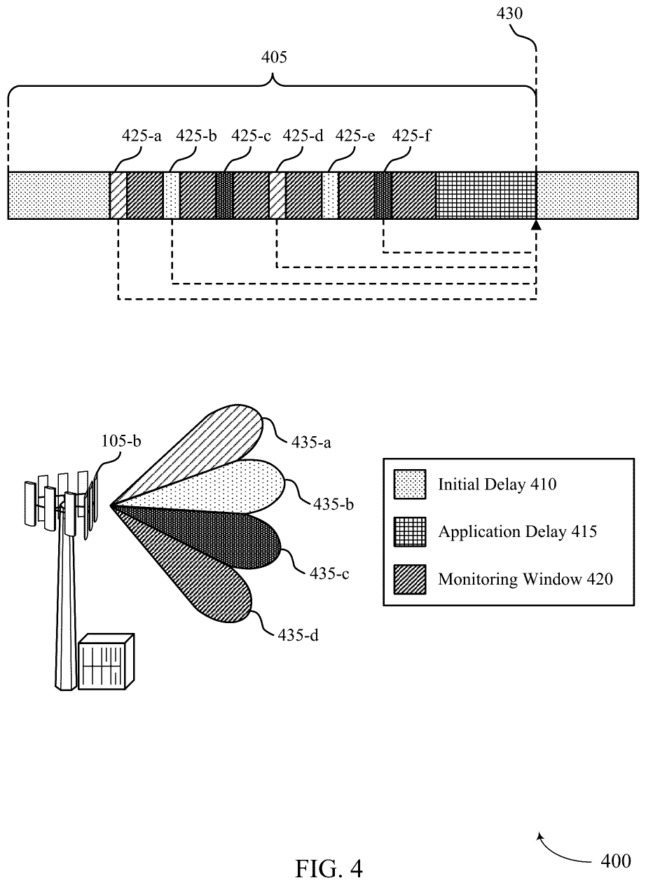

FIG. 4 shows an example of a signaling diagram 400 that supports window configuration for cellular discontinuous communications in accordance with one or more aspects of the present disclosure. The signaling diagram 400 may implement or be implemented by aspects FIGS. 1-3. For example, the signaling diagram 400 may include a network entity 105-b, which may be an example of network entities 105 and network entity 105-a of FIGS. 1 and 2, respectively. The signaling diagram may also include a periodic interval 405 comprising an initial delay 410, application delays 415, monitoring windows (e.g., monitoring window 420), GC DCI messages 425 (e.g., GC DCI message 425-a, GC DCI message 425-b, GC DCI message 425-c, GC DCI message 425-d, GC DCI message 425-e, and GC DCI message 425-f), and a starting candidate position 430, which may correspond to respective aspects of FIG. 3. Although exemplary quantities of durations, periods, or messaging are depicted in the signaling diagram 400, this disclosure may be generalized or extended to include any quantity of such durations, periods, and messaging.

The signaling diagram 400 illustrates the network entity 105-b transmitting multiple GC DCI messages 425 via multiple transmit beams 435. The multiple transmit beams 435 may be associated with a beam sweeping procedure. In some systems, beam sweeping for GC DCI messaging may increase the reliability of delivery for the GC DCI messages 425.

In some cases, each transmit beam 435 may correspond to (e.g., be used to transmit) one or more GC DCI messages 425 transmitted in the monitoring window 420. For example, the transmit beam 435-a may correspond to the GC DCI messages 425-a and 425-d, the transmit beam 435-b may correspond to the GC DCI messages 425-b and 425-e, the transmit beam 435-c may correspond to the GC DCI messages 425-c and 425-f, and the transmit beam 435-d may correspond to one or more additional GC DCI messages. In some systems, the network entity 105-b may determine or configure the parameters or the transmit beams 435, which transmit beams 435 to include in the beam sweeping procedure, and the quantity of GC DCI messages 425 to transmit via each transmit beam 435 during the monitoring window 420. In some cases, the transmit beams 435 may be associated with one or more different directions, frequencies, bandwidths, or other beamforming parameters.

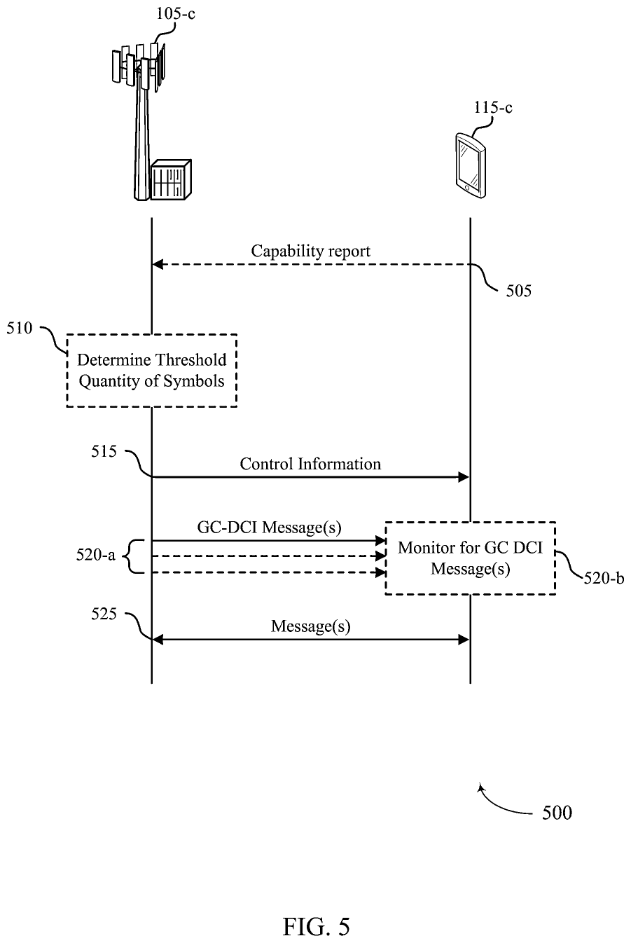

FIG. 5 shows an example of a process flow 500 that supports window configuration for cellular discontinuous communications in accordance with one or more aspects of the present disclosure. The process flow 500 may implement or be implemented by aspects of FIGS. 1-4. For example, the process flow 500 may include a network entity 105-c and a UE 115-c, which may be examples of network entities 105 and UEs 115 of FIGS. 1, 2, and 4. Additionally, some aspects of process flow 500 may be associated with or based on the discontinuous communications, the periodic intervals 305, and the periodic intervals 405 of FIGS. 3 and 4.

In the following description of process flow 500, the operations may be performed in a different order than the order shown, or other operations may be added or removed from the process flow 500. For example, some operations may also be left out of process flow 500, may be performed in different orders or at different times, or other operations may be added to process flow 500. Although the UE 115-c and the network entity 105-c are shown performing the operations of process flow 500, some aspects of some operations may also be performed by one or more other wireless devices or network devices.

At 505, the UE 115-c may transmit a capability report associated with GC DCI messaging to the network entity 105-c. In some cases, the capability report may include one or more values, where at least one of the values corresponds to at least a smallest quantity of symbols in which the UE 115-c is capable to apply changes for the discontinuous operational mode indicated by a GC DCI message. The capability report may comprise other indications of parameters of the UE 115-c associated with GC DCI messaging and discontinuous operation.

At 510, the network entity 105-c may determine a threshold quantity of symbols for the duration of one or more application delays for the discontinuous operation mode window configuration. The threshold quantity of symbols may be based on the capability report received at the network entity 105-c from UE 115-c and one or more other UEs. For example, the network entity 105-c may select a largest value of the values received in the capability reports as the threshold quantity of symbols. In this way, the network entity 105-c may select a threshold quantity of symbols large enough to allow all of the UEs that transmitted a capability report to the network entity 105-c to apply changes for the discontinuous operation mode within the application delay.

At 515, the network entity 105-c may transmit control information to the UE 115-c. The network entity 105-c may transmit the control information to the UE 115-c via a downlink control channel, or via a broadcast or multicast method. The control information may indicate a periodic interval, as well as a monitoring window, an initial delay, and an application delay within the periodic interval. The control information may further indicate one or more monitoring occasions (e.g., PDCCH monitoring occasions) within the monitoring window, where the monitoring window is for the network entity 105-c to transmit GC DCI messages within the monitoring occasions and for the UE 115-c to receive the GC DCI messages within the monitoring occasions.

Additionally or alternatively, the control information may indicate other aspects of the periodic interval. For example, the control information may indicate a duration for the periodic interval, a starting offset for the periodic interval (e.g., a chronologically first periodic interval) relative to a radio frame boundary, or both. The control information may also indicate a duration for the monitoring window, an initial delay for the monitoring window relative to a first symbol of the periodic interval, or both. Additionally or alternatively, the control information may indicate the application delay of the periodic interval, where the application delay may be a delay duration between a last symbol of a downlink control channel within the monitoring window and a first slot of a next periodic interval.

At 520-a, the network entity 105-c may transmit one or more GC DCI messages during the monitoring window. The network entity 105-c may transmit the one or more GC DCI messages during the monitoring occasions of the monitoring window. The network entity 105-c may determine a quantity of instances of the GC DCI messages to be sent during the monitoring window, where each instance of the GC DCI message in the monitoring window carries the same information (e.g., DCI information).

The GC DCI messages may contain information related to a cell-based discontinuous operation mode for the one or more serving cells associated with the network entity 105-c. For example, the GC DCI messages may contain an indication of an activation or a deactivation for cell-based discontinuous communications. The indication of the activation or the deactivation may be a common flag associate with one or more serving cells. For example, the network entity may configure a subset of serving cells from a set of serving cells, where the subset of serving cells may be associated with the common flag. The subset of serving cells may be aligned such that each serving cell of the subset of serving cells activates or deactivates the discontinuous operation mode according to the indication in the common flag.

Cell-based discontinuous communications may be associated with a DTX mode, a DRX mode, or both, which may be configured jointly or separately. The indication of the activation or the deactivation may also be associated with the DTX mode, the DRX mode, or both. In one example, if the DTX mode and the DRX mode are jointly configured, the indication of the activation or the deactivation may contain one bit. The one bit may indicate the activation or the deactivation of both the DTX mode and the DRX mode. In another example, if the DTX mode and the DRX mode are separately configured, the indication of the activation or the deactivation may contain two bits. Of the two bits, one bit may indicate the activation or the deactivation of the DTX mode, and the other bit may indicate the activation or the deactivation of the DRX mode.

The network entity 105-c may transmit the GC DCI messages as part of a beam sweeping procedure (e.g., operation). For example, one or more of the GC DCI messages may correspond to a first transmit beam, and another one or more of the GC DCI messages may correspond to a second transmit beam. The network entity 105-c may determine the quantity of transmit beams, the parameters of each transmit beam, and the quantity of DCI messages to transmit via each transmit beam of the beam sweeping procedure. The beam sweeping procedure may increase the reliability of the GC DCI messaging between the network entity 105-c and the UE 115-c.

At 520-b, the UE 115-c may monitor for the GC DCI messages in the monitoring occasions of the monitoring window. As discussed herein, the GC DCI messages may contain information associated with cell-based discontinuous communications, such as an indication of the activation or the deactivation of the discontinuous operation mode in one or more serving cells.

The UE 115-c may monitor all or part of the monitoring windows of the discontinuous operation mode. For example, the UE 115-c may monitor a monitoring window until the UE 115-c receives a GC DCI message. In some cases, the UE 115-c may refrain from monitoring for the rest (e.g., a remaining quantity) of the GC DCI messages within the monitoring window after the having received the GC DCI message. In some other cases, the UE 115-c may continue to monitor for the rest of the GC DCI messages within the monitoring window after having received the GC DCI message.

At 525, the network entity 105-c and the UE 115-c may communicate messages according to cell-based discontinuous communications. For example, the network entity 105-c may refrain from transmitting messages (e.g., downlink messaging) or from receiving messages (e.g., uplink messaging) during a cell-based DTX off duration or a cell-based DRX off duration, respectively. Likewise, the UE 115-c may refrain from transmitting messages (e.g., uplink messaging) or monitoring for messages (e.g., downlink messaging) during a cell based DRX off-duration or a cell-based DTX off-duration.

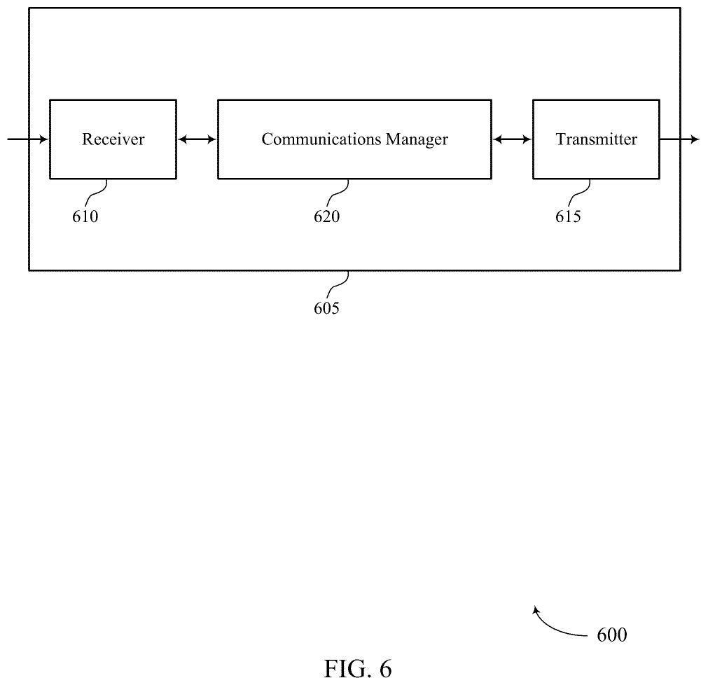

FIG. 6 shows a block diagram 600 of a device 605 that supports window configuration for cellular discontinuous communications in accordance with one or more aspects of the present disclosure. The device 605 may be an example of aspects of a UE 115 as described herein. The device 605 may include a receiver 610, a transmitter 615, and a communications manager 620. The device 605, or one or more components of the device 605 (e.g., the receiver 610, the transmitter 615, and the communications manager 620), may include at least one processor, which may be coupled with at least one memory, to, individually or collectively, support or enable the described techniques. Each of these components may be in communication with one another (e.g., via one or more buses).

The receiver 610 may provide a means for receiving information such as packets, user data, control information, or any combination thereof associated with various information channels (e.g., control channels, data channels, information channels related to window configuration for cellular discontinuous communications). Information may be passed on to other components of the device 605. The receiver 610 may utilize a single antenna or a set of multiple antennas.

The transmitter 615 may provide a means for transmitting signals generated by other components of the device 605. For example, the transmitter 615 may transmit information such as packets, user data, control information, or any combination thereof associated with various information channels (e.g., control channels, data channels, information channels related to window configuration for cellular discontinuous communications). In some examples, the transmitter 615 may be co-located with a receiver 610 in a transceiver module. The transmitter 615 may utilize a single antenna or a set of multiple antennas.

The communications manager 620, the receiver 610, the transmitter 615, or various combinations thereof or various components thereof may be examples of means for performing various aspects of window configuration for cellular discontinuous communications as described herein. For example, the communications manager 620, the receiver 610, the transmitter 615, or various combinations or components thereof may be capable of performing one or more of the functions described herein.

In some examples, the communications manager 620, the receiver 610, the transmitter 615, or various combinations or components thereof may be implemented in hardware (e.g., in communications management circuitry). The hardware may include at least one of a processor, a digital signal processor (DSP), a central processing unit (CPU), an application-specific integrated circuit (ASIC), a field-programmable gate array (FPGA) or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (e.g., by one or more processors, individually or collectively, executing instructions stored in the at least one memory).

Additionally, or alternatively, the communications manager 620, the receiver 610, the transmitter 615, or various combinations or components thereof may be implemented in code (e.g., as communications management software or firmware) executed by at least one processor. If implemented in code executed by at least one processor, the functions of the communications manager 620, the receiver 610, the transmitter 615, or various combinations or components thereof may be performed by a general-purpose processor, a DSP, a CPU, an ASIC, an FPGA, a microcontroller, or any combination of these or other programmable logic devices (e.g., configured as or otherwise supporting, individually or collectively, a means for performing the functions described in the present disclosure).

In some examples, the communications manager 620 may be configured to perform various operations (e.g., receiving, obtaining, monitoring, outputting, transmitting) using or otherwise in cooperation with the receiver 610, the transmitter 615, or both. For example, the communications manager 620 may receive information from the receiver 610, send information to the transmitter 615, or be integrated in combination with the receiver 610, the transmitter 615, or both to obtain information, output information, or perform various other operations as described herein.

The communications manager 620 may support wireless communication in accordance with examples as disclosed herein. For example, the communications manager 620 is capable of, configured to, or operable to support a means for receiving control information that indicates a periodic interval and a monitoring window within the periodic interval, where the monitoring window is for receipt of one or more instances of a GC DCI message. The communications manager 620 is capable of, configured to, or operable to support a means for receiving, within the monitoring window, at least one instance of the GC DCI message in accordance with the control information, the at least one instance of the GC DCI message including a configuration for a cell-based discontinuous operation mode. The communications manager 620 is capable of, configured to, or operable to support a means for communicating with a network entity in accordance with the configuration for the cell-based discontinuous operation mode.

By including or configuring the communications manager 620 in accordance with examples as described herein, the device 605 (e.g., at least one processor controlling or otherwise coupled with the receiver 610, the transmitter 615, the communications manager 620, or a combination thereof) may support techniques for increased network energy efficiency. For example, the UE may more reliably communicate GC DCI messaging and discontinuous operation mode messaging. The increased reliability may lead to power savings at the UE due to refraining from monitoring for or transmitting messages during cell-based DTX or DRX off durations, respectively.

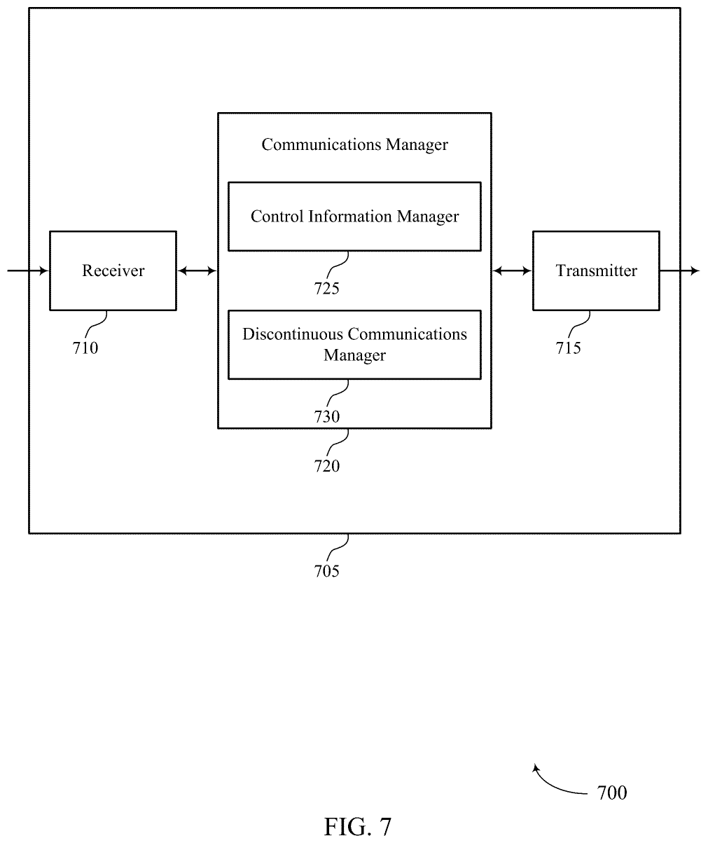

FIG. 7 shows a block diagram 700 of a device 705 that supports window configuration for cellular discontinuous communications in accordance with one or more aspects of the present disclosure. The device 705 may be an example of aspects of a device 605 or a UE 115 as described herein. The device 705 may include a receiver 710, a transmitter 715, and a communications manager 720. The device 705, or one of more components of the device 705 (e.g., the receiver 710, the transmitter 715, and the communications manager 720), may include at least one processor, which may be coupled with at least one memory, to support the described techniques. Each of these components may be in communication with one another (e.g., via one or more buses).

The receiver 710 may provide a means for receiving information such as packets, user data, control information, or any combination thereof associated with various information channels (e.g., control channels, data channels, information channels related to window configuration for cellular discontinuous communications). Information may be passed on to other components of the device 705. The receiver 710 may utilize a single antenna or a set of multiple antennas.

The transmitter 715 may provide a means for transmitting signals generated by other components of the device 705. For example, the transmitter 715 may transmit information such as packets, user data, control information, or any combination thereof associated with various information channels (e.g., control channels, data channels, information channels related to window configuration for cellular discontinuous communications). In some examples, the transmitter 715 may be co-located with a receiver 710 in a transceiver module. The transmitter 715 may utilize a single antenna or a set of multiple antennas.

The device 705, or various components thereof, may be an example of means for performing various aspects of window configuration for cellular discontinuous communications as described herein. For example, the communications manager 720 may include a control information manager 725 a discontinuous communications manager 730, or any combination thereof. The communications manager 720 may be an example of aspects of a communications manager 620 as described herein. In some examples, the communications manager 720, or various components thereof, may be configured to perform various operations (e.g., receiving, obtaining, monitoring, outputting, transmitting) using or otherwise in cooperation with the receiver 710, the transmitter 715, or both. For example, the communications manager 720 may receive information from the receiver 710, send information to the transmitter 715, or be integrated in combination with the receiver 710, the transmitter 715, or both to obtain information, output information, or perform various other operations as described herein.

The communications manager 720 may support wireless communication in accordance with examples as disclosed herein. The control information manager 725 is capable of, configured to, or operable to support a means for receiving control information that indicates a periodic interval and a monitoring window within the periodic interval, where the monitoring window is for receipt of one or more instances of a GC DCI message. The control information manager 725 is capable of, configured to, or operable to support a means for receiving, within the monitoring window, at least one instance of the GC DCI message in accordance with the control information, the at least one instance of the GC DCI message including a configuration for a cell-based discontinuous operation mode. The discontinuous communications manager 730 is capable of, configured to, or operable to support a means for communicating with a network entity in accordance with the configuration for the cell-based discontinuous operation mode.

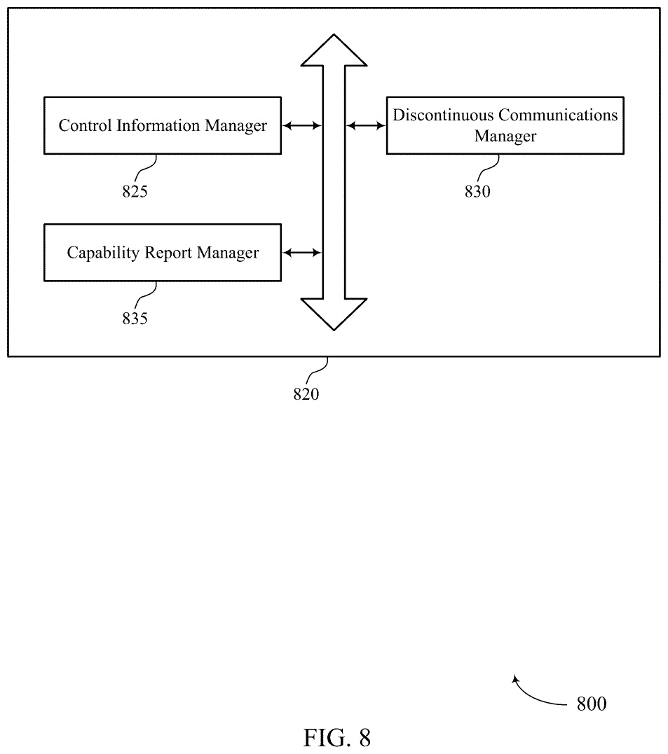

FIG. 8 shows a block diagram 800 of a communications manager 820 that supports window configuration for cellular discontinuous communications in accordance with one or more aspects of the present disclosure. The communications manager 820 may be an example of aspects of a communications manager 620, a communications manager 720, or both, as described herein. The communications manager 820, or various components thereof, may be an example of means for performing various aspects of window configuration for cellular discontinuous communications as described herein. For example, the communications manager 820 may include a control information manager 825, a discontinuous communications manager 830, a capability report manager 835, or any combination thereof. Each of these components, or components or subcomponents thereof (e.g., one or more processors, one or more memories), may communicate, directly or indirectly, with one another (e.g., via one or more buses).

The communications manager 820 may support wireless communication in accordance with examples as disclosed herein. The control information manager 825 is capable of, configured to, or operable to support a means for receiving control information that indicates a periodic interval and a monitoring window within the periodic interval, where the monitoring window is for receipt of one or more instances of a GC DCI message. In some examples, the control information manager 825 is capable of, configured to, or operable to support a means for receiving, within the monitoring window, at least one instance of the GC DCI message in accordance with the control information, the at least one instance of the GC DCI message including a configuration for a cell-based discontinuous operation mode. The discontinuous communications manager 830 is capable of, configured to, or operable to support a means for communicating with a network entity in accordance with the configuration for the cell-based discontinuous operation mode.

In some examples, the control information indicates a duration for the periodic interval, a starting offset for the periodic interval relative to a radio frame boundary, or both.

In some examples, the control information indicates a duration for the monitoring window, one or more control channel monitoring occasions within the monitoring window for receipt of the at least one instance of the GC DCI message, a starting offset for the monitoring window relative to a first symbol of the periodic interval, or any combination thereof.

In some examples, to support receiving the at least one instance of the GC DCI message, the control information manager 825 is capable of, configured to, or operable to support a means for receiving the at least one instance of the GC DCI message during a first monitoring occasion of one or more monitoring occasions within the monitoring window. In some examples, to support receiving the at least one instance of the GC DCI message, the control information manager 825 is capable of, configured to, or operable to support a means for refraining from monitoring at least one other monitoring occasion of the one or more monitoring occasions that occurs after the first monitoring occasion within the monitoring window based on receipt of the at least one instance of the GC DCI message during the first monitoring occasion.

In some examples, the control information indicates a delay duration between a last symbol of a downlink control channel received within the monitoring window and a first slot of a second periodic interval following the periodic interval. In some examples, an instance of the GC DCI message is received via the downlink control channel.

In some examples, the delay duration is larger than or equal to a threshold quantity of symbols. In some examples, the threshold quantity of symbols is a set quantity of symbols that corresponds to a subcarrier spacing of a set of multiple subcarrier spacings for symbols of the downlink control channel within the monitoring window.

In some examples, the capability report manager 835 is capable of, configured to, or operable to support a means for transmitting, to the network entity, a UE capability report that indicates a minimum delay duration supported by the UE, where the threshold quantity of symbols is based on the UE capability report.

In some examples, the threshold quantity of symbols is based on whether the configuration for the cell-based discontinuous operation mode indicates an activation status or a deactivation status, whether the configuration for the cell-based discontinuous operation mode configures one or more of a DRX mode or a DTX mode, or both.

In some examples, the at least one instance of the GC DCI message includes a one-bit indication of an activation or deactivation of the cell-based discontinuous operation mode when the cell-based discontinuous operation mode includes a DRX mode and DTX mode that are jointly configured.

In some examples, the at least one instance of the GC DCI message includes a two-bit indication of an activation or deactivation of the cell-based discontinuous operation mode when the cell-based discontinuous operation mode includes a DRX mode and a DTX mode that are separately configured. In some examples, a first bit of the two-bit indication corresponds to the DRX mode and a second bit of the two-bit indication corresponds to the DTX mode.

In some examples, the at least one instance of the GC DCI message includes an indication of an activation status or a deactivation status of the cell-based discontinuous operation mode for a set of serving cells configured by the network entity. In some examples, the activation status or the deactivation status is applied to the cell-based discontinuous operation mode for each serving cell of the set of serving cells.

In some examples, the control information manager 825 is capable of, configured to, or operable to support a means for monitoring for the at least one instance of the GC DCI message in a primary serving cell associated with the UE or in a special serving cell associated with the UE, or both, where receiving the at least one instance of the GC DCI message is based on the monitoring.

In some examples, each of the one or more instances of the GC DCI message within the monitoring window includes a same DCI message. In some examples, the cell-based discontinuous operation mode is a cell DRX mode, a cell DTX mode, or both.

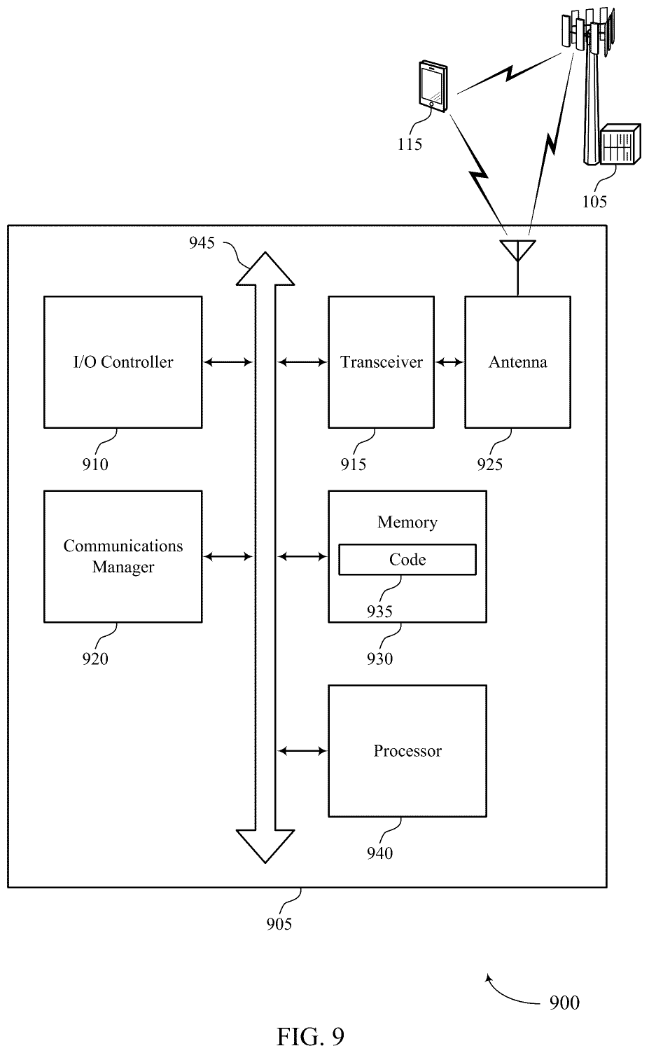

FIG. 9 shows a diagram of a system 900 including a device 905 that supports window configuration for cellular discontinuous communications in accordance with one or more aspects of the present disclosure. The device 905 may be an example of or include the components of a device 605, a device 705, or a UE 115 as described herein. The device 905 may communicate (e.g., wirelessly) with one or more network entities 105, one or more UEs 115, or any combination thereof. The device 905 may include components for bi-directional voice and data communications including components for transmitting and receiving communications, such as a communications manager 920, an input/output (I/O) controller 910, a transceiver 915, an antenna 925, at least one memory 930, code 935, and at least one processor 940. These components may be in electronic communication or otherwise coupled (e.g., operatively, communicatively, functionally, electronically, electrically) via one or more buses (e.g., a bus 945).

The I/O controller 910 may manage input and output signals for the device 905. The I/O controller 910 may also manage peripherals not integrated into the device 905. In some cases, the I/O controller 910 may represent a physical connection or port to an external peripheral. In some cases, the I/O controller 910 may utilize an operating system such as iOS®, ANDROID®, MS-DOS®, MS-WINDOWS®, OS/2®, UNIX®, LINUX®, or another known operating system. Additionally or alternatively, the I/O controller 910 may represent or interact with a modem, a keyboard, a mouse, a touchscreen, or a similar device. In some cases, the I/O controller 910 may be implemented as part of one or more processors, such as the at least one processor 940. In some cases, a user may interact with the device 905 via the I/O controller 910 or via hardware components controlled by the I/O controller 910.

In some cases, the device 905 may include a single antenna 925. However, in some other cases, the device 905 may have more than one antenna 925, which may be capable of concurrently transmitting or receiving multiple wireless transmissions. The transceiver 915 may communicate bi-directionally, via the one or more antennas 925, wired, or wireless links as described herein. For example, the transceiver 915 may represent a wireless transceiver and may communicate bi-directionally with another wireless transceiver. The transceiver 915 may also include a modem to modulate the packets, to provide the modulated packets to one or more antennas 925 for transmission, and to demodulate packets received from the one or more antennas 925. The transceiver 915, or the transceiver 915 and one or more antennas 925, may be an example of a transmitter 615, a transmitter 715, a receiver 610, a receiver 710, or any combination thereof or component thereof, as described herein.

The at least one memory 930 may include random access memory (RAM) and read-only memory (ROM). The at least one memory 930 may store computer-readable, computer-executable code 935 including instructions that, when executed by the at least one processor 940, cause the device 905 to perform various functions described herein. The code 935 may be stored in a non-transitory computer-readable medium such as system memory or another type of memory. In some cases, the code 935 may not be directly executable by the at least one processor 940 but may cause a computer (e.g., when compiled and executed) to perform functions described herein. In some cases, the at least one memory 930 may contain, among other things, a basic I/O system (BIOS) which may control basic hardware or software operation such as the interaction with peripheral components or devices.

The at least one processor 940 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some cases, the at least one processor 940 may be configured to operate a memory array using a memory controller. In some other cases, a memory controller may be integrated into the at least one processor 940. The at least one processor 940 may be configured to execute computer-readable instructions stored in a memory (e.g., the at least one memory 930) to cause the device 905 to perform various functions (e.g., functions or tasks supporting window configuration for cellular discontinuous communications). For example, the device 905 or a component of the device 905 may include at least one processor 940 and at least one memory 930 coupled with or to the at least one processor 940, the at least one processor 940 and at least one memory 930 configured to perform various functions described herein. In some examples, the at least one processor 940 may include multiple processors and the at least one memory 930 may include multiple memories. One or more of the multiple processors may be coupled with one or more of the multiple memories, which may, individually or collectively, be configured to perform various functions herein. In some examples, the at least one processor 940 may be a component of a processing system, which may refer to a system (such as a series) of machines, circuitry (including, for example, one or both of processor circuitry (which may include the at least one processor 940) and memory circuitry (which may include the at least one memory 930)), or components, that receives or obtains inputs and processes the inputs to produce, generate, or obtain a set of outputs. The processing system may be configured to perform one or more of the functions described herein. As such, the at least one processor 940 or a processing system including the at least one processor 940 may be configured to, configurable to, or operable to cause the device 905 to perform one or more of the functions described herein. Further, as described herein, being “configured to,” being “configurable to,” and being “operable to” may be used interchangeably and may be associated with a capability, when executing code stored in the at least one memory 930 or otherwise, to perform one or more of the functions described herein.

The communications manager 920 may support wireless communication in accordance with examples as disclosed herein. For example, the communications manager 920 is capable of, configured to, or operable to support a means for receiving control information that indicates a periodic interval and a monitoring window within the periodic interval, where the monitoring window is for receipt of one or more instances of a GC DCI message. The communications manager 920 is capable of, configured to, or operable to support a means for receiving, within the monitoring window, at least one instance of the GC DCI message in accordance with the control information, the at least one instance of the GC DCI message including a configuration for a cell-based discontinuous operation mode. The communications manager 920 is capable of, configured to, or operable to support a means for communicating with a network entity in accordance with the configuration for the cell-based discontinuous operation mode.

By including or configuring the communications manager 920 in accordance with examples as described herein, the device 905 may support techniques for improved communications reliability at the UE, specifically during GC DCI communications and discontinuous operation mode communications. For example, the UE may more reliably receive GC DCI messaging due to the monitoring window being aligned between the UE and the network entity. Since the GC DCI messaging contains information associated with cell-based discontinuous operation mode communications, the UE may more reliably communicate during discontinuous operation modes, leading to less latency due to mis-detecting transmissions.

In some examples, the communications manager 920 may be configured to perform various operations (e.g., receiving, monitoring, transmitting) using or otherwise in cooperation with the transceiver 915, the one or more antennas 925, or any combination thereof. Although the communications manager 920 is illustrated as a separate component, in some examples, one or more functions described with reference to the communications manager 920 may be supported by or performed by the at least one processor 940, the at least one memory 930, the code 935, or any combination thereof. For example, the code 935 may include instructions executable by the at least one processor 940 to cause the device 905 to perform various aspects of window configuration for cellular discontinuous communications as described herein, or the at least one processor 940 and the at least one memory 930 may be otherwise configured to, individually or collectively, perform or support such operations.

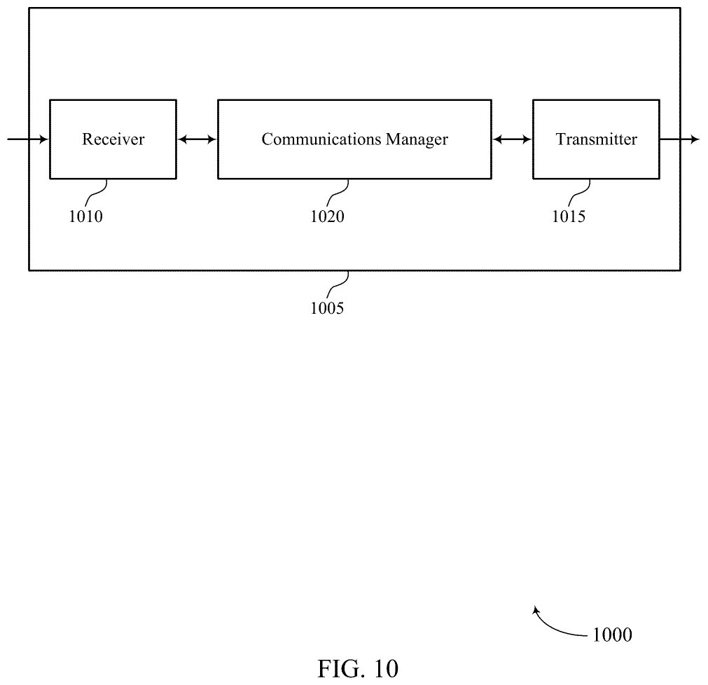

FIG. 10 shows a block diagram 1000 of a device 1005 that supports window configuration for cellular discontinuous communications in accordance with one or more aspects of the present disclosure. The device 1005 may be an example of aspects of a network entity 105 as described herein. The device 1005 may include a receiver 1010, a transmitter 1015, and a communications manager 1020. The device 1005, or one or more components of the device 1005 (e.g., the receiver 1010, the transmitter 1015, and the communications manager 1020), may include at least one processor, which may be coupled with at least one memory, to, individually or collectively, support or enable the described techniques. Each of these components may be in communication with one another (e.g., via one or more buses).

The receiver 1010 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 1005. In some examples, the receiver 1010 may support obtaining information by receiving signals via one or more antennas. Additionally, or alternatively, the receiver 1010 may support obtaining information by receiving signals via one or more wired (e.g., electrical, fiber optic) interfaces, wireless interfaces, or any combination thereof.

The transmitter 1015 may provide a means for outputting (e.g., transmitting, providing, conveying, sending) information generated by other components of the device 1005. For example, the transmitter 1015 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 1015 may support outputting information by transmitting signals via one or more antennas. Additionally, or alternatively, the transmitter 1015 may support outputting information by transmitting signals via one or more wired (e.g., electrical, fiber optic) interfaces, wireless interfaces, or any combination thereof. In some examples, the transmitter 1015 and the receiver 1010 may be co-located in a transceiver, which may include or be coupled with a modem.

The communications manager 1020, the receiver 1010, the transmitter 1015, or various combinations thereof or various components thereof may be examples of means for performing various aspects of window configuration for cellular discontinuous communications as described herein. For example, the communications manager 1020, the receiver 1010, the transmitter 1015, or various combinations or components thereof may be capable of performing one or more of the functions described herein.

In some examples, the communications manager 1020, the receiver 1010, the transmitter 1015, or various combinations or components thereof may be implemented in hardware (e.g., in communications management circuitry). The hardware may include at least one of a processor, a DSP, a CPU, an ASIC, an FPGA or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (e.g., by one or more processors, individually or collectively, executing instructions stored in the at least one memory).

Additionally, or alternatively, the communications manager 1020, the receiver 1010, the transmitter 1015, or various combinations or components thereof may be implemented in code (e.g., as communications management software or firmware) executed by at least one processor. If implemented in code executed by at least one processor, the functions of the communications manager 1020, the receiver 1010, the transmitter 1015, or various combinations or components thereof may be performed by a general-purpose processor, a DSP, a CPU, an ASIC, an FPGA, a microcontroller, or any combination of these or other programmable logic devices (e.g., configured as or otherwise supporting, individually or collectively, a means for performing the functions described in the present disclosure).

In some examples, the communications manager 1020 may be configured to perform various operations (e.g., receiving, obtaining, monitoring, outputting, transmitting) using or otherwise in cooperation with the receiver 1010, the transmitter 1015, or both. For example, the communications manager 1020 may receive information from the receiver 1010, send information to the transmitter 1015, or be integrated in combination with the receiver 1010, the transmitter 1015, or both to obtain information, output information, or perform various other operations as described herein.

The communications manager 1020 may support wireless communication in accordance with examples as disclosed herein. For example, the communications manager 1020 is capable of, configured to, or operable to support a means for transmitting control information that indicates a periodic interval and a monitoring window within the periodic interval, where the monitoring window is for transmission of one or more instances of a GC DCI message to one or more UEs. The communications manager 1020 is capable of, configured to, or operable to support a means for transmitting, within the monitoring window, at least one instance of the GC DCI message in accordance with the control information, the at least one instance of the GC DCI message including a configuration for a cell-based discontinuous operation mode. The communications manager 1020 is capable of, configured to, or operable to support a means for communicating with at least one UE of the one or more UEs in accordance with the configuration for the cell-based discontinuous operation mode.

By including or configuring the communications manager 1020 in accordance with examples as described herein, the device 1005 (e.g., at least one processor controlling or otherwise coupled with the receiver 1010, the transmitter 1015, the communications manager 1020, or a combination thereof) may support techniques for increased network energy efficiency. For example, the network entity may spend less time monitoring for messages during cell-based DRX off durations and transmitting messages during cell-based DTX off durations. These may lead to less power usage, and thus network energy savings.

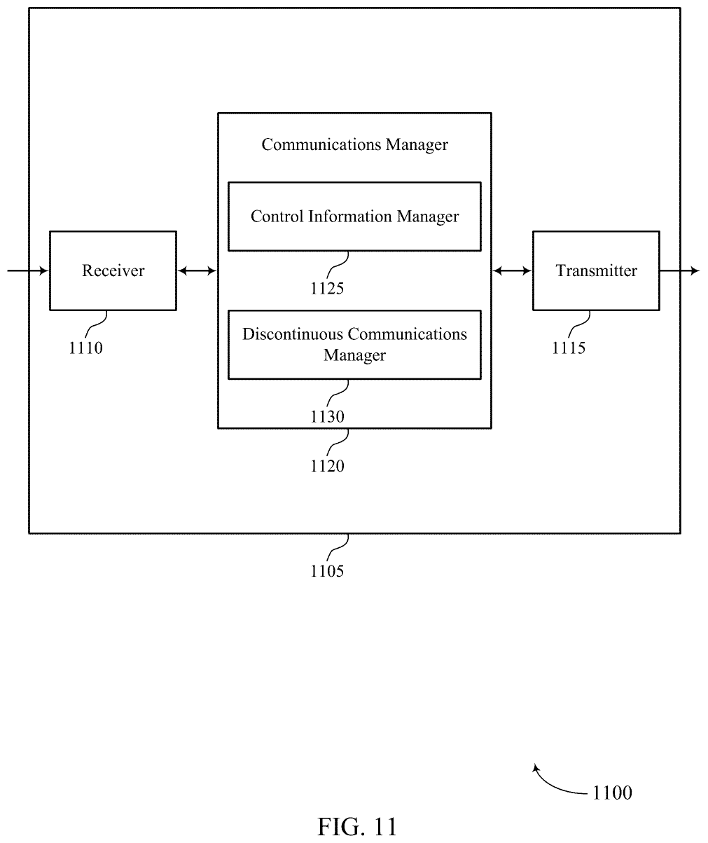

FIG. 11 shows a block diagram 1100 of a device 1105 that supports window configuration for cellular discontinuous communications in accordance with one or more aspects of the present disclosure. The device 1105 may be an example of aspects of a device 1005 or a network entity 105 as described herein. The device 1105 may include a receiver 1110, a transmitter 1115, and a communications manager 1120. The device 1105, or one of more components of the device 1105 (e.g., the receiver 1110, the transmitter 1115, and the communications manager 1120), may include at least one processor, which may be coupled with at least one memory, to support the described techniques. Each of these components may be in communication with one another (e.g., via one or more buses).

The receiver 1110 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 1105. In some examples, the receiver 1110 may support obtaining information by receiving signals via one or more antennas. Additionally, or alternatively, the receiver 1110 may support obtaining information by receiving signals via one or more wired (e.g., electrical, fiber optic) interfaces, wireless interfaces, or any combination thereof.

The transmitter 1115 may provide a means for outputting (e.g., transmitting, providing, conveying, sending) information generated by other components of the device 1105. For example, the transmitter 1115 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 1115 may support outputting information by transmitting signals via one or more antennas. Additionally, or alternatively, the transmitter 1115 may support outputting information by transmitting signals via one or more wired (e.g., electrical, fiber optic) interfaces, wireless interfaces, or any combination thereof. In some examples, the transmitter 1115 and the receiver 1110 may be co-located in a transceiver, which may include or be coupled with a modem.

The device 1105, or various components thereof, may be an example of means for performing various aspects of window configuration for cellular discontinuous communications as described herein. For example, the communications manager 1120 may include a control information manager 1125 a discontinuous communications manager 1130, or any combination thereof. The communications manager 1120 may be an example of aspects of a communications manager 1020 as described herein. In some examples, the communications manager 1120, or various components thereof, may be configured to perform various operations (e.g., receiving, obtaining, monitoring, outputting, transmitting) using or otherwise in cooperation with the receiver 1110, the transmitter 1115, or both. For example, the communications manager 1120 may receive information from the receiver 1110, send information to the transmitter 1115, or be integrated in combination with the receiver 1110, the transmitter 1115, or both to obtain information, output information, or perform various other operations as described herein.

The communications manager 1120 may support wireless communication in accordance with examples as disclosed herein. The control information manager 1125 is capable of, configured to, or operable to support a means for transmitting control information that indicates a periodic interval and a monitoring window within the periodic interval, where the monitoring window is for transmission of one or more instances of a GC DCI message to one or more UEs. The control information manager 1125 is capable of, configured to, or operable to support a means for transmitting, within the monitoring window, at least one instance of the GC DCI message in accordance with the control information, the at least one instance of the GC DCI message including a configuration for a cell-based discontinuous operation mode. The discontinuous communications manager 1130 is capable of, configured to, or operable to support a means for communicating with at least one UE of the one or more UEs in accordance with the configuration for the cell-based discontinuous operation mode.

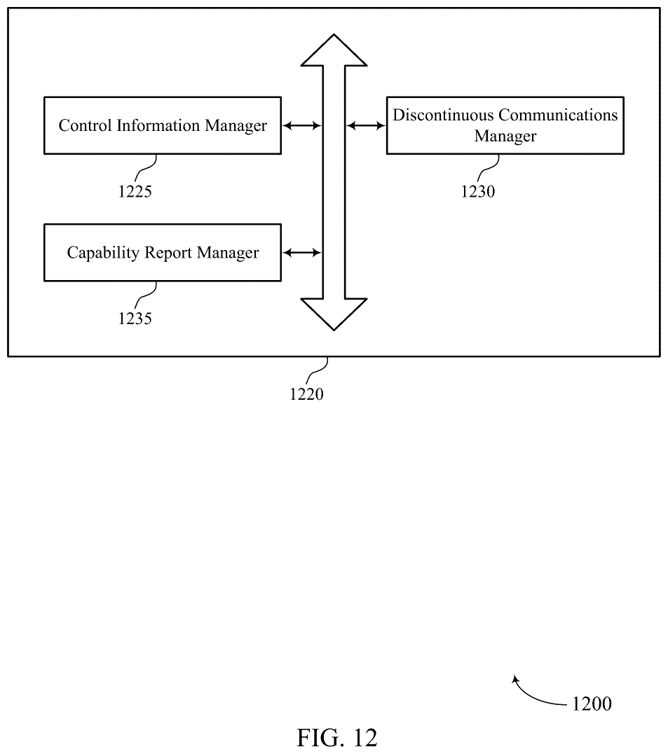

FIG. 12 shows a block diagram 1200 of a communications manager 1220 that supports window configuration for cellular discontinuous communications in accordance with one or more aspects of the present disclosure. The communications manager 1220 may be an example of aspects of a communications manager 1020, a communications manager 1120, or both, as described herein. The communications manager 1220, or various components thereof, may be an example of means for performing various aspects of window configuration for cellular discontinuous communications as described herein. For example, the communications manager 1220 may include a control information manager 1225, a discontinuous communications manager 1230, a capability report manager 1235, or any combination thereof. Each of these components, or components or subcomponents thereof (e.g., one or more processors, one or more memories), may communicate, directly or indirectly, with one another (e.g., via one or more buses) which may include communications within a protocol layer of a protocol stack, communications associated with a logical channel of a protocol stack (e.g., between protocol layers of a protocol stack, within a device, component, or virtualized component associated with a network entity 105, between devices, components, or virtualized components associated with a network entity 105), or any combination thereof.

The communications manager 1220 may support wireless communication in accordance with examples as disclosed herein. The control information manager 1225 is capable of, configured to, or operable to support a means for transmitting control information that indicates a periodic interval and a monitoring window within the periodic interval, where the monitoring window is for transmission of one or more instances of a GC DCI message to one or more UEs. In some examples, the control information manager 1225 is capable of, configured to, or operable to support a means for transmitting, within the monitoring window, at least one instance of the GC DCI message in accordance with the control information, the at least one instance of the GC DCI message including a configuration for a cell-based discontinuous operation mode. The discontinuous communications manager 1230 is capable of, configured to, or operable to support a means for communicating with at least one UE of the one or more UEs in accordance with the configuration for the cell-based discontinuous operation mode.

In some examples, the control information indicates a duration for the periodic interval, a starting offset for the periodic interval relative to a radio frame boundary, or both. In some examples, the control information indicates a duration for the monitoring window, one or more control channel monitoring occasions within the monitoring window for receipt of the at least one instance of the GC DCI message, a starting offset for the monitoring window relative to a first symbol of the periodic interval, or any combination thereof.

In some examples, the control information indicates a delay duration between a last symbol of a downlink control channel transmitted within the monitoring window and a first slot of a second periodic interval following the periodic interval. In some examples, an instance of the GC DCI message is transmitted via the downlink control channel.

In some examples, the delay duration is larger than or equal to a threshold quantity of symbols that corresponds to a subcarrier spacing of a set of multiple subcarrier spacings for symbols of the downlink control channel within the monitoring window.

In some examples, the capability report manager 1235 is capable of, configured to, or operable to support a means for receiving, from the at least one UE, one or more UE capability reports that indicate respective minimum delay durations supported by each respective UE of the at least one UE, where the delay duration is larger than or equal to a quantity of symbols associated with a largest delay duration of the respective minimum delay durations.

In some examples, the delay duration is larger than or equal to a threshold quantity of symbols that is based on whether the configuration for the cell-based discontinuous operation mode indicates an activation status or a deactivation status, whether the configuration for the cell-based discontinuous operation mode configures one or more of a DRX mode or a DTX mode, or both.

In some examples, the at least one instance of the GC DCI message includes a one-bit indication of an activation status or a deactivation status of the cell-based discontinuous operation mode when the cell-based discontinuous operation mode includes a DRX mode and a DTX mode that are jointly configured or a two-bit indication of the activation status or the deactivation status of the cell-based discontinuous operation mode when the cell-based discontinuous operation mode includes the DRX mode and the DTX mode that are separately configured.

In some examples, the at least one instance of the GC DCI message includes an indication of an activation status or a deactivation status of the cell-based discontinuous operation mode for a set of serving cells configured by the network entity. In some examples, the activation status or the deactivation status is applied to the cell-based discontinuous operation mode for each serving cell of the set of serving cells.

In some examples, to support transmitting the at least one instance of the GC DCI message, the control information manager 1225 is capable of, configured to, or operable to support a means for transmitting, during a beam sweep, a first instance of the GC DCI message via a first transmit beam. In some examples, to support transmitting the at least one instance of the GC DCI message, the control information manager 1225 is capable of, configured to, or operable to support a means for transmitting, during the beam sweep, a second instance of the GC DCI message via a second transmit beam that is different from the first transmit beam.

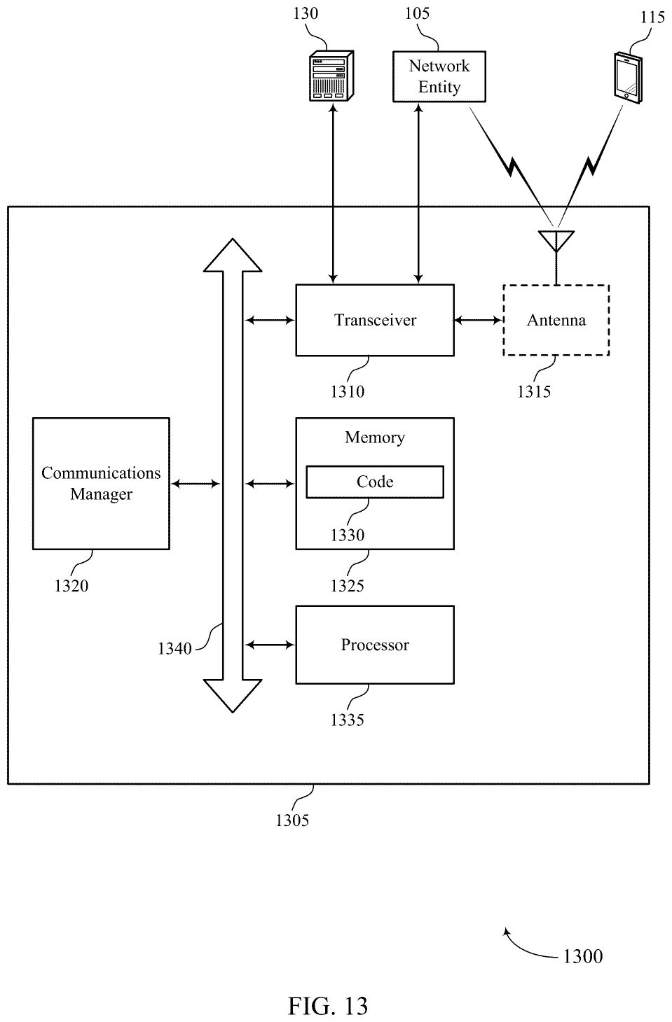

FIG. 13 shows a diagram of a system 1300 including a device 1305 that supports window configuration for cellular discontinuous communications in accordance with one or more aspects of the present disclosure. The device 1305 may be an example of or include the components of a device 1005, a device 1105, or a network entity 105 as described herein. The device 1305 may communicate with one or more network entities 105, one or more UEs 115, or any combination thereof, which may include communications over one or more wired interfaces, over one or more wireless interfaces, or any combination thereof. The device 1305 may include components that support outputting and obtaining communications, such as a communications manager 1320, a transceiver 1310, an antenna 1315, at least one memory 1325, code 1330, and at least one processor 1335. These components may be in electronic communication or otherwise coupled (e.g., operatively, communicatively, functionally, electronically, electrically) via one or more buses (e.g., a bus 1340).

The transceiver 1310 may support bi-directional communications via wired links, wireless links, or both as described herein. In some examples, the transceiver 1310 may include a wired transceiver and may communicate bi-directionally with another wired transceiver. Additionally, or alternatively, in some examples, the transceiver 1310 may include a wireless transceiver and may communicate bi-directionally with another wireless transceiver. In some examples, the device 1305 may include one or more antennas 1315, which may be capable of transmitting or receiving wireless transmissions (e.g., concurrently). The transceiver 1310 may also include a modem to modulate signals, to provide the modulated signals for transmission (e.g., by one or more antennas 1315, by a wired transmitter), to receive modulated signals (e.g., from one or more antennas 1315, from a wired receiver), and to demodulate signals. In some implementations, the transceiver 1310 may include one or more interfaces, such as one or more interfaces coupled with the one or more antennas 1315 that are configured to support various receiving or obtaining operations, or one or more interfaces coupled with the one or more antennas 1315 that are configured to support various transmitting or outputting operations, or a combination thereof. In some implementations, the transceiver 1310 may include or be configured for coupling with one or more processors or one or more memory components that are operable to perform or support operations based on received or obtained information or signals, or to generate information or other signals for transmission or other outputting, or any combination thereof. In some implementations, the transceiver 1310, or the transceiver 1310 and the one or more antennas 1315, or the transceiver 1310 and the one or more antennas 1315 and one or more processors or one or more memory components (e.g., the at least one processor 1335, the at least one memory 1325, or both), may be included in a chip or chip assembly that is installed in the device 1305. In some examples, the transceiver 1310 may be operable to support communications via one or more communications links (e.g., a communication link 125, a backhaul communication link 120, a midhaul communication link 162, a fronthaul communication link 168).

The at least one memory 1325 may include RAM, ROM, or any combination thereof. The at least one memory 1325 may store computer-readable, computer-executable code 1330 including instructions that, when executed by one or more of the at least one processor 1335, cause the device 1305 to perform various functions described herein. The code 1330 may be stored in a non-transitory computer-readable medium such as system memory or another type of memory. In some cases, the code 1330 may not be directly executable by a processor of the at least one processor 1335 but may cause a computer (e.g., when compiled and executed) to perform functions described herein. In some cases, the at least one memory 1325 may contain, among other things, a BIOS which may control basic hardware or software operation such as the interaction with peripheral components or devices. In some examples, the at least one processor 1335 may include multiple processors and the at least one memory 1325 may include multiple memories. One or more of the multiple processors may be coupled with one or more of the multiple memories which may, individually or collectively, be configured to perform various functions herein (for example, as part of a processing system).

The at least one processor 1335 may include an intelligent hardware device (e.g., a general-purpose processor, a DSP, an ASIC, a CPU, an FPGA, a microcontroller, a programmable logic device, discrete gate or transistor logic, a discrete hardware component, or any combination thereof). In some cases, the at least one processor 1335 may be configured to operate a memory array using a memory controller. In some other cases, a memory controller may be integrated into one or more of the at least one processor 1335. The at least one processor 1335 may be configured to execute computer-readable instructions stored in a memory (e.g., one or more of the at least one memory 1325) to cause the device 1305 to perform various functions (e.g., functions or tasks supporting window configuration for cellular discontinuous communications). For example, the device 1305 or a component of the device 1305 may include at least one processor 1335 and at least one memory 1325 coupled with one or more of the at least one processor 1335, the at least one processor 1335 and the at least one memory 1325 configured to perform various functions described herein. The at least one processor 1335 may be an example of a cloud-computing platform (e.g., one or more physical nodes and supporting software such as operating systems, virtual machines, or container instances) that may host the functions (e.g., by executing code 1330) to perform the functions of the device 1305. The at least one processor 1335 may be any one or more suitable processors capable of executing scripts or instructions of one or more software programs stored in the device 1305 (such as within one or more of the at least one memory 1325). In some examples, the at least one processor 1335 may include multiple processors and the at least one memory 1325 may include multiple memories. One or more of the multiple processors may be coupled with one or more of the multiple memories, which may, individually or collectively, be configured to perform various functions herein. In some examples, the at least one processor 1335 may be a component of a processing system, which may refer to a system (such as a series) of machines, circuitry (including, for example, one or both of processor circuitry (which may include the at least one processor 1335) and memory circuitry (which may include the at least one memory 1325)), or components, that receives or obtains inputs and processes the inputs to produce, generate, or obtain a set of outputs. The processing system may be configured to perform one or more of the functions described herein. As such, the at least one processor 1335 or a processing system including the at least one processor 1335 may be configured to, configurable to, or operable to cause the device 1305 to perform one or more of the functions described herein. Further, as described herein, being “configured to,” being “configurable to,” and being “operable to” may be used interchangeably and may be associated with a capability, when executing code stored in the at least one memory 1325 or otherwise, to perform one or more of the functions described herein.

In some examples, a bus 1340 may support communications of (e.g., within) a protocol layer of a protocol stack. In some examples, a bus 1340 may support communications associated with a logical channel of a protocol stack (e.g., between protocol layers of a protocol stack), which may include communications performed within a component of the device 1305, or between different components of the device 1305 that may be co-located or located in different locations (e.g., where the device 1305 may refer to a system in which one or more of the communications manager 1320, the transceiver 1310, the at least one memory 1325, the code 1330, and the at least one processor 1335 may be located in one of the different components or divided between different components).

In some examples, the communications manager 1320 may manage aspects of communications with a core network 130 (e.g., via one or more wired or wireless backhaul links). For example, the communications manager 1320 may manage the transfer of data communications for client devices, such as one or more UEs 115. In some examples, the communications manager 1320 may manage communications with other network entities 105, and may include a controller or scheduler for controlling communications with UEs 115 in cooperation with other network entities 105. In some examples, the communications manager 1320 may support an X2 interface within an LTE/LTE-A wireless communications network technology to provide communication between network entities 105.

The communications manager 1320 may support wireless communication in accordance with examples as disclosed herein. For example, the communications manager 1320 is capable of, configured to, or operable to support a means for transmitting control information that indicates a periodic interval and a monitoring window within the periodic interval, where the monitoring window is for transmission of one or more instances of a GC DCI message to one or more UEs. The communications manager 1320 is capable of, configured to, or operable to support a means for transmitting, within the monitoring window, at least one instance of the GC DCI message in accordance with the control information, the at least one instance of the GC DCI message including a configuration for a cell-based discontinuous operation mode. The communications manager 1320 is capable of, configured to, or operable to support a means for communicating with at least one UE of the one or more UEs in accordance with the configuration for the cell-based discontinuous operation mode.

By including or configuring the communications manager 1320 in accordance with examples as described herein, the device 1305 may support techniques for enhancing the reliability of GC DCI messaging and discontinuous operation mode communications at the network entity. For example, the network entity may more reliably transmit CG DCI messaging due to configuring the cell-base discontinuous operation mode window, which may allow for the network entity to more reliably communicate according to cell-based discontinuous communications.

In some examples, the communications manager 1320 may be configured to perform various operations (e.g., receiving, obtaining, monitoring, outputting, transmitting) using or otherwise in cooperation with the transceiver 1310, the one or more antennas 1315 (e.g., where applicable), or any combination thereof. Although the communications manager 1320 is illustrated as a separate component, in some examples, one or more functions described with reference to the communications manager 1320 may be supported by or performed by the transceiver 1310, one or more of the at least one processor 1335, one or more of the at least one memory 1325, the code 1330, or any combination thereof (for example, by a processing system including at least a portion of the at least one processor 1335, the at least one memory 1325, the code 1330, or any combination thereof). For example, the code 1330 may include instructions executable by one or more of the at least one processor 1335 to cause the device 1305 to perform various aspects of window configuration for cellular discontinuous communications as described herein, or the at least one processor 1335 and the at least one memory 1325 may be otherwise configured to, individually or collectively, perform or support such operations.

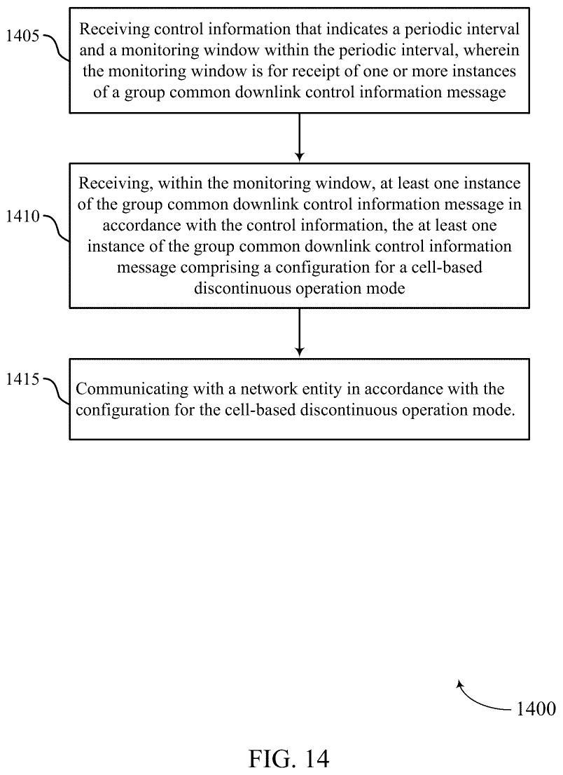

FIG. 14 shows a flowchart illustrating a method 1400 that supports window configuration for cellular discontinuous communications in accordance with aspects of the present disclosure. The operations of the method 1400 may be implemented by a UE or its components as described herein. For example, the operations of the method 1400 may be performed by a UE 115 as described with reference to FIGS. 1 through 9. In some examples, a UE may execute a set of instructions to control the functional elements of the UE to perform the described functions. Additionally, or alternatively, the UE may perform aspects of the described functions using special-purpose hardware.

At 1405, the method may include receiving control information that indicates a periodic interval and a monitoring window within the periodic interval, where the monitoring window is for receipt of one or more instances of a GC DCI message. The operations of block 1405 may be performed in accordance with examples as disclosed herein. In some examples, aspects of the operations of 1405 may be performed by a control information manager 825 as described with reference to FIG. 8.

At 1410, the method may include receiving, within the monitoring window, at least one instance of the GC DCI message in accordance with the control information, the at least one instance of the GC DCI message including a configuration for a cell-based discontinuous operation mode. The operations of block 1410 may be performed in accordance with examples as disclosed herein. In some examples, aspects of the operations of 1410 may be performed by a control information manager 825 as described with reference to FIG. 8.

At 1415, the method may include communicating with a network entity in accordance with the configuration for the cell-based discontinuous operation mode. The operations of block 1415 may be performed in accordance with examples as disclosed herein. In some examples, aspects of the operations of 1415 may be performed by a discontinuous communications manager 830 as described with reference to FIG. 8.

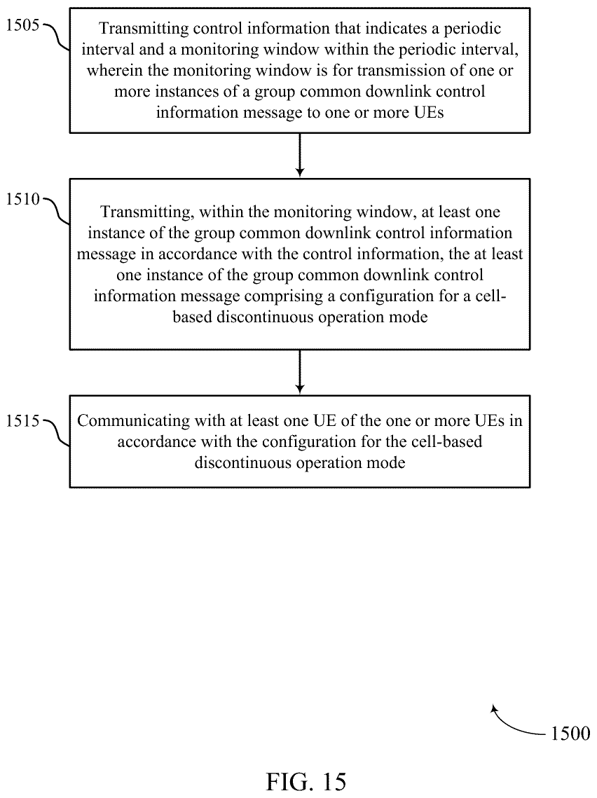

FIG. 15 shows a flowchart illustrating a method 1500 that supports window configuration for cellular discontinuous communications in accordance with aspects of the present disclosure. The operations of the method 1500 may be implemented by a network entity or its components as described herein. For example, the operations of the method 1500 may be performed by a network entity as described with reference to FIGS. 1 through 5 and 10 through 13. In some examples, a network entity may execute a set of instructions to control the functional elements of the network entity to perform the described functions. Additionally, or alternatively, the network entity may perform aspects of the described functions using special-purpose hardware.

At 1505, the method may include transmitting control information that indicates a periodic interval and a monitoring window within the periodic interval, where the monitoring window is for transmission of one or more instances of a GC DCI message to one or more UEs. The operations of block 1505 may be performed in accordance with examples as disclosed herein. In some examples, aspects of the operations of 1505 may be performed by a control information manager 1225 as described with reference to FIG. 12.

At 1510, the method may include transmitting, within the monitoring window, at least one instance of the GC DCI message in accordance with the control information, the at least one instance of the GC DCI message including a configuration for a cell-based discontinuous operation mode. The operations of block 1510 may be performed in accordance with examples as disclosed herein. In some examples, aspects of the operations of 1510 may be performed by a control information manager 1225 as described with reference to FIG. 12.

At 1515, the method may include communicating with at least one UE of the one or more UEs in accordance with the configuration for the cell-based discontinuous operation mode. The operations of block 1515 may be performed in accordance with examples as disclosed herein. In some examples, aspects of the operations of 1515 may be performed by a discontinuous communications manager 1230 as described with reference to FIG. 12.

The following provides an overview of aspects of the present disclosure:

Aspect 1: A method for wireless communication at a UE, comprising: receiving control information that indicates a periodic interval and a monitoring window within the periodic interval, wherein the monitoring window is for receipt of one or more instances of a GC DCI message; receiving, within the monitoring window, at least one instance of the GC DCI message in accordance with the control information, the at least one instance of the GC DCI message comprising a configuration for a cell-based discontinuous operation mode; and communicating with a network entity in accordance with the configuration for the cell-based discontinuous operation mode.

Aspect 2: The method of aspect 1, wherein the control information indicates a duration for the periodic interval, a starting offset for the periodic interval relative to a radio frame boundary, or both.

Aspect 3: The method of any of aspects 1 through 2, wherein the control information indicates a duration for the monitoring window, one or more control channel monitoring occasions within the monitoring window for receipt of the at least one instance of the GC DCI message, a starting offset for the monitoring window relative to a first symbol of the periodic interval, or any combination thereof.

Aspect 4: The method of aspect 3, wherein receiving the at least one instance of the GC DCI message further comprises: receiving the at least one instance of the GC DCI message during a first monitoring occasion of one or more monitoring occasions within the monitoring window; and refraining from monitoring at least one other monitoring occasion of the one or more monitoring occasions that occurs after the first monitoring occasion within the monitoring window based at least in part on receipt of the at least one instance of the GC DCI message during the first monitoring occasion.

Aspect 5: The method of any of aspects 1 through 4, wherein the control information indicates a delay duration between a last symbol of a downlink control channel received within the monitoring window and a first slot of a second periodic interval following the periodic interval, and an instance of the GC DCI message is received via the downlink control channel.

Aspect 6: The method of aspect 5, wherein the delay duration is larger than or equal to a threshold quantity of symbols.

Aspect 7: The method of aspect 6, wherein the threshold quantity of symbols is a set quantity of symbols that corresponds to a subcarrier spacing of a plurality of subcarrier spacings for symbols of the downlink control channel within the monitoring window.

Aspect 8: The method of any of aspects 6 through 7, further comprising: transmitting, to the network entity, a UE capability report that indicates a minimum delay duration supported by the UE, wherein the threshold quantity of symbols is based at least in part on the UE capability report.

Aspect 9: The method of any of aspects 6 through 8, wherein the threshold quantity of symbols is based at least in part on whether the configuration for the cell-based discontinuous operation mode indicates an activation status or a deactivation status, whether the configuration for the cell-based discontinuous operation mode configures one or more of a DRX mode or a DTX mode, or both.

Aspect 10: The method of any of aspects 1 through 9, wherein the at least one instance of the GC DCI message comprises a one-bit indication of an activation or deactivation of the cell-based discontinuous operation mode when the cell-based discontinuous operation mode includes a DRX mode and DTX mode that are jointly configured.

Aspect 11: The method of any of aspects 1 through 9, wherein the at least one instance of the GC DCI message comprises a two-bit indication of an activation or deactivation of the cell-based discontinuous operation mode when the cell-based discontinuous operation mode includes a DRX mode and a DTX mode that are separately configured, a first bit of the two-bit indication corresponds to the DRX mode and a second bit of the two-bit indication corresponds to the DTX mode.

Aspect 12: The method of any of aspects 1 through 11, wherein the at least one instance of the GC DCI message comprises an indication of an activation status or a deactivation status of the cell-based discontinuous operation mode for a set of serving cells configured by the network entity, and the activation status or the deactivation status is applied to the cell-based discontinuous operation mode for each serving cell of the set of serving cells.

Aspect 13: The method of aspect 12, further comprising: monitoring for the at least one instance of the GC DCI message in a primary serving cell associated with the UE or in a special serving cell associated with the UE, or both, wherein receiving the at least one instance of the GC DCI message is based at least in part on the monitoring.

Aspect 14: The method of any of aspects 1 through 13, wherein each of the one or more instances of the GC DCI message within the monitoring window comprises a same DCI message.

Aspect 15: The method of any of aspects 1 through 14, wherein the cell-based discontinuous operation mode is a cell DRX mode, a cell DTX mode, or both.

Aspect 16: A method for wireless communication at a network entity, comprising: transmitting control information that indicates a periodic interval and a monitoring window within the periodic interval, wherein the monitoring window is for transmission of one or more instances of a GC DCI message to one or more UEs; transmitting, within the monitoring window, at least one instance of the GC DCI message in accordance with the control information, the at least one instance of the GC DCI message comprising a configuration for a cell-based discontinuous operation mode; and communicating with at least one UE of the one or more UEs in accordance with the configuration for the cell-based discontinuous operation mode.

Aspect 17: The method of aspect 16, wherein the control information indicates a duration for the periodic interval, a starting offset for the periodic interval relative to a radio frame boundary, or both.

Aspect 18: The method of any of aspects 16 through 17, wherein the control information indicates a duration for the monitoring window, one or more control channel monitoring occasions within the monitoring window for receipt of the at least one instance of the GC DCI message, a starting offset for the monitoring window relative to a first symbol of the periodic interval, or any combination thereof.

Aspect 19: The method of any of aspects 16 through 18, wherein the control information indicates a delay duration between a last symbol of a downlink control channel transmitted within the monitoring window and a first slot of a second periodic interval following the periodic interval, and an instance of the GC DCI message is transmitted via the downlink control channel.

Aspect 20: The method of aspect 19, wherein the delay duration is larger than or equal to a threshold quantity of symbols that corresponds to a subcarrier spacing of a plurality of subcarrier spacings for symbols of the downlink control channel within the monitoring window.

Aspect 21: The method of any of aspects 19 through 20, further comprising: receiving, from the at least one UE, one or more UE capability reports that indicate respective minimum delay durations supported by each respective UE of the at least one UE, wherein the delay duration is larger than or equal to a quantity of symbols associated with a largest delay duration of the respective minimum delay durations.

Aspect 22: The method of any of aspects 19 through 21, wherein the delay duration is larger than or equal to a threshold quantity of symbols that is based at least in part on whether the configuration for the cell-based discontinuous operation mode indicates an activation status or a deactivation status, whether the configuration for the cell-based discontinuous operation mode configures one or more of a DRX mode or a DTX mode, or both.

Aspect 23: The method of any of aspects 16 through 22, wherein the at least one instance of the GC DCI message comprises a one-bit indication of an activation status or a deactivation status of the cell-based discontinuous operation mode when the cell-based discontinuous operation mode includes a DRX mode and a DTX mode that are jointly configured or a two-bit indication of the activation status or the deactivation status of the cell-based discontinuous operation mode when the cell-based discontinuous operation mode includes the DRX mode and the DTX mode that are separately configured.

Aspect 24: The method of any of aspects 16 through 23, wherein the at least one instance of the GC DCI message comprises an indication of an activation status or a deactivation status of the cell-based discontinuous operation mode for a set of serving cells configured by the network entity, and the activation status or the deactivation status is applied to the cell-based discontinuous operation mode for each serving cell of the set of serving cells.

Aspect 25: The method of any of aspects 16 through 24, wherein transmitting the at least one instance of the GC DCI message comprises: transmitting, during a beam sweep, a first instance of the GC DCI message via a first transmit beam; and transmitting, during the beam sweep, a second instance of the GC DCI message via a second transmit beam that is different from the first transmit beam.

Aspect 26: A UE for wireless communication, comprising one or more memories storing processor-executable code, and one or more processors coupled with the one or more memories and individually or collectively operable to execute the code to cause the UE to perform a method of any of aspects 1 through 15.

Aspect 27: A UE for wireless communication, comprising at least one means for performing a method of any of aspects 1 through 15.

Aspect 28: A non-transitory computer-readable medium storing code for wireless communication, the code comprising instructions executable by a processor to perform a method of any of aspects 1 through 15.

Aspect 29: A network entity for wireless communication, comprising one or more memories storing processor-executable code, and one or more processors coupled with the one or more memories and individually or collectively operable to execute the code to cause the network entity to perform a method of any of aspects 16 through 25.

Aspect 30: A network entity for wireless communication, comprising at least one means for performing a method of any of aspects 16 through 25.

Aspect 31: A non-transitory computer-readable medium storing code for wireless communication, the code comprising instructions executable by a processor to perform a method of any of aspects 16 through 25.

It should be noted that the methods described herein describe possible implementations, and that the operations and the steps may be rearranged or otherwise modified and that other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed using a general-purpose processor, a DSP, an ASIC, a CPU, an FPGA or other programmable logic device, discrete gate or transistor logic, discrete hardware components, or any combination thereof designed to perform the functions described herein. A general-purpose processor may be a microprocessor but, in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration). Any functions or operations described herein as being capable of being performed by a processor may be performed by multiple processors that, individually or collectively, are capable of performing the described functions or operations.

The functions described herein may be implemented using hardware, software executed by a processor, firmware, or any combination thereof. If implemented using software executed by a processor, the functions may be stored as or transmitted using one or more instructions or code of a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one location to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk and Blu-ray disc. Disks may reproduce data magnetically, and discs may reproduce data optically using lasers. Combinations of the above are also included within the scope of computer-readable media. Any functions or operations described herein as being capable of being performed by a memory may be performed by multiple memories that, individually or collectively, are capable of performing the described functions or operations.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

As used herein, including in the claims, the article “a” before a noun is open-ended and understood to refer to “at least one” of those nouns or “one or more” of those nouns. Thus, the terms “a,” “at least one,” “one or more,” “at least one of one or more” may be interchangeable. For example, if a claim recites “a component” that performs one or more functions, each of the individual functions may be performed by a single component or by any combination of multiple components. Thus, the term “a component” having characteristics or performing functions may refer to “at least one of one or more components” having a particular characteristic or performing a particular function. Subsequent reference to a component introduced with the article “a” using the terms “the” or “said” may refer to any or all of the one or more components. For example, a component introduced with the article “a” may be understood to mean “one or more components,” and referring to “the component” subsequently in the claims may be understood to be equivalent to referring to “at least one of the one or more components.” Similarly, subsequent reference to a component introduced as “one or more components” using the terms “the” or “said” may refer to any or all of the one or more components. For example, referring to “the one or more components” subsequently in the claims may be understood to be equivalent to referring to “at least one of the one or more components.”

The term “determine” or “determining” encompasses a variety of actions and, therefore, “determining” can include calculating, computing, processing, deriving, investigating, looking up (such as via looking up in a table, a database or another data structure), ascertaining and the like. Also, “determining” can include receiving (e.g., receiving information), accessing (e.g., accessing data stored in memory) and the like. Also, “determining” can include resolving, obtaining, selecting, choosing, establishing, and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label, or other subsequent reference label.

The description set forth herein, in connection with the appended drawings, describes example configurations and does not represent all the examples that may be implemented or that are within the scope of the claims. The term “example” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A user equipment (UE), comprising:
one or more memories storing processor-executable code; and
one or more processors coupled with the one or more memories and individually or collectively operable to execute the code to cause the UE to:
receive control information that indicates a periodic interval and a monitoring window within the periodic interval, wherein the monitoring window is for receipt of one or more instances of a group common downlink control information message;
receive, within the monitoring window, at least one instance of the group common downlink control information message in accordance with the control information, the at least one instance of the group common downlink control information message comprising a configuration for a cell-based discontinuous operation mode; and
communicate with a network entity in accordance with the configuration for the cell-based discontinuous operation mode.

2. The UE of claim 1, wherein the control information indicates a duration for the periodic interval, a starting offset for the periodic interval relative to a radio frame boundary, or both.

3. The UE of claim 1, wherein the control information indicates a duration for the monitoring window, one or more control channel monitoring occasions within the monitoring window for receipt of the at least one instance of the group common downlink control information message, a starting offset for the monitoring window relative to a first symbol of the periodic interval, or any combination thereof.

4. The UE of claim 3, wherein, to receive the at least one instance of the group common downlink control information message, the one or more processors are individually or collectively further operable to execute the code to cause the UE to:
receive the at least one instance of the group common downlink control information message during a first monitoring occasion of one or more monitoring occasions within the monitoring window; and
refrain from monitoring at least one other monitoring occasion of the one or more monitoring occasions that occurs after the first monitoring occasion within the monitoring window based at least in part on receipt of the at least one instance of the group common downlink control information message during the first monitoring occasion.

5. The UE of claim 1, wherein:
the control information indicates a delay duration between a last symbol of a downlink control channel received within the monitoring window and a first slot of a second periodic interval following the periodic interval, and
an instance of the group common downlink control information message is received via the downlink control channel.

6. The UE of claim 5, wherein the delay duration is larger than or equal to a threshold quantity of symbols.

7. The UE of claim 6, wherein the threshold quantity of symbols is a set quantity of symbols that corresponds to a subcarrier spacing of a plurality of subcarrier spacings for symbols of the downlink control channel within the monitoring window.

8. The UE of claim 6, wherein the one or more processors are individually or collectively further operable to execute the code to cause the UE to:
transmit, to the network entity, a UE capability report that indicates a minimum delay duration supported by the UE, wherein the threshold quantity of symbols is based at least in part on the UE capability report.

9. The UE of claim 6, wherein the threshold quantity of symbols is based at least in part on whether the configuration for the cell-based discontinuous operation mode indicates an activation status or a deactivation status, whether the configuration for the cell-based discontinuous operation mode configures one or more of a discontinuous reception mode or a discontinuous transmission mode, or both.

10. The UE of claim 1, wherein the at least one instance of the group common downlink control information message comprises a one-bit indication of an activation or deactivation of the cell-based discontinuous operation mode when the cell-based discontinuous operation mode includes a discontinuous reception mode and discontinuous transmission mode that are jointly configured.

11. The UE of claim 1, wherein the at least one instance of the group common downlink control information message comprises a two-bit indication of an activation or deactivation of the cell-based discontinuous operation mode when the cell-based discontinuous operation mode includes a discontinuous reception mode and a discontinuous transmission mode that are separately configured, and a first bit of the two-bit indication corresponds to the discontinuous reception mode and a second bit of the two-bit indication corresponds to the discontinuous transmission mode.

12. The UE of claim 1, wherein the at least one instance of the group common downlink control information message comprises an indication of an activation status or a deactivation status of the cell-based discontinuous operation mode for a set of serving cells configured by the network entity, and the activation status or the deactivation status is applied to the cell-based discontinuous operation mode for each serving cell of the set of serving cells.

13. The UE of claim 12, wherein the one or more processors are individually or collectively further operable to execute the code to cause the UE to:
monitor for the at least one instance of the group common downlink control information message in a primary serving cell associated with the UE or in a special serving cell associated with the UE, or both, wherein receiving the at least one instance of the group common downlink control information message is based at least in part on the monitoring.

14. The UE of claim 1, wherein each of the one or more instances of the group common downlink control information message within the monitoring window comprises a same downlink control information message.

15. The UE of claim 1, wherein the cell-based discontinuous operation mode is a cell discontinuous reception mode, a cell discontinuous transmission mode, or both.

16. A method for wireless communication at a user equipment (UE), comprising:
receiving control information that indicates a periodic interval and a monitoring window within the periodic interval, wherein the monitoring window is for receipt of one or more instances of a group common downlink control information message;
receiving, within the monitoring window, at least one instance of the group common downlink control information message in accordance with the control information, the at least one instance of the group common downlink control information message comprising a configuration for a cell-based discontinuous operation mode; and
communicating with a network entity in accordance with the configuration for the cell-based discontinuous operation mode.

17. The method of claim 16, wherein the control information indicates a duration for the periodic interval, a starting offset for the periodic interval relative to a radio frame boundary, or both.

18. The method of claim 16, wherein the control information indicates a duration for the monitoring window, one or more control channel monitoring occasions within the monitoring window for receipt of the at least one instance of the group common downlink control information message, a starting offset for the monitoring window relative to a first symbol of the periodic interval, or any combination thereof.

19. The method of claim 16, wherein receiving the at least one instance of the group common downlink control information message comprises:
receiving the at least one instance of the group common downlink control information message during a first monitoring occasion of one or more monitoring occasions within the monitoring window; and
refraining from monitoring at least one other monitoring occasion of the one or more monitoring occasions that occurs after the first monitoring occasion within the monitoring window based at least in part on receipt of the at least one instance of the group common downlink control information message during the first monitoring occasion.

20. A user equipment (UE), comprising:
means for receiving control information that indicates a periodic interval and a monitoring window within the periodic interval, wherein the monitoring window is for receipt of one or more instances of a group common downlink control information message;
means for receiving, within the monitoring window, at least one instance of the group common downlink control information message in accordance with the control information, the at least one instance of the group common downlink control information message comprising a configuration for a cell-based discontinuous operation mode; and
means for communicating with a network entity in accordance with the configuration for the cell-based discontinuous operation mode.
